(19) United States
(12) Patent Application Publication
(10) Pub. No.: US 2025/0234048 A1
(43) Pub. Date: Jul. 17, 2025

(54) NEURAL NETWORK VIDEO CODING IN-LOOP FILTERING IN TRANSFORM DOMAIN

(71) Applicant: QUALCOMM Incorporated, San Diego, CA (US)

(72) Inventors: Yun Li, Ottobrunn (DE); Dmytro Rusanovskyy, San Diego, CA (US); Marta Karczewicz, San Diego, CA (US)

(21) Appl. No.: 18/987,925

(22) Filed: Dec. 19, 2024

Related U.S. Application Data
(60) Provisional application No. 63/621,516, filed on Jan. 16, 2024.

(51) Int. Cl. H04N 19/82; H04N 19/117; H04N 19/122; H04N 19/159; H04N 19/176; H04N 19/63

(52) U.S. Cl. CPC H04N 19/82; H04N 19/117; H04N 19/122; H04N 19/159; H04N 19/176; H04N 19/63

(57) ABSTRACT

A method of coding video data, the method comprising: obtaining input data, wherein the input data includes one or more of predicted video data, reconstructed video data, quantization parameter data, boundary strength data, or prediction mode data; converting the input data from an input domain to a transform domain to generate converted video data; applying a neural network (NN)-based in-loop filter (ILF) to the converted video data to generate filtered video data; and converting the filtered video data from the transform domain to the input domain.

This application claims the benefit of U.S. Provisional Patent Application 63/621,516, filed Jan. 16, 2024, the entire content of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for neural network-based in-loop filtering (NN-ILF) in video coding. As described herein, techniques of this disclosure may improve coding performance under complexity and memory requirements constraints. In the state-of-the-art convolutional neural network (CNN) in-loop filters, filtering is often conducted in the YUV domain. This can result in a non-optimal design for certain dimensions and with respect to capturing signal correlations. The techniques of this disclosure may mitigate the impact of non-optimality by introducing a transform process to the input signals. The techniques described in this document are related to CNN-assisted loop filtering, however, they are applicable to any CNN-based video coding tool that consumes input data with certain statistical properties. Techniques may be used in the context of advanced video codecs, such as extensions of Versatile Video Coding (VVC) or the next generation of video coding standards, and any other video codecs.

In one example, this disclosure describes a method of coding video data, the method comprising: obtaining input data, wherein the input data includes one or more of predicted video data, reconstructed video data, quantization parameter data, boundary strength data, or prediction mode data; converting the input data from an input domain to a transform domain to generate converted video data; applying a neural network (NN)-based in-loop filter (ILF) to the converted video data to generate filtered video data; and converting the filtered video data from the transform domain to the input domain.

In another example, this disclosure describes a device for coding video data, the device comprising: one or more memories to store the video data; and one or more processors implemented in circuitry, the one or more processors configured to: obtain input data, wherein the input data includes one or more of predicted video data, reconstructed video data, quantization parameter data, boundary strength data, or prediction mode data; convert the input data from an input domain to a transform domain to generate converted video data; apply a neural network (NN)-based in-loop filter (ILF) to the converted video data to generate filtered video data; and convert the filtered video data from the transform domain to the input domain.

In another example, this disclosure describes one or more non-transitory computer-readable storage media having stored thereon instructions that, when executed by one or more processors, cause the one or more processors to: obtain input data, wherein the input data includes one or more of predicted video data, reconstructed video data, quantization parameter data, boundary strength data, or prediction mode data; convert the input data from an input domain to a transform domain to generate converted video data; apply a neural network (NN)-based in-loop filter (ILF) to the converted video data to generate filtered video data; and convert the filtered video data from the transform domain to the input domain.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example quadtree binary tree (QTBT) structure, and a corresponding coding tree unit (CTU).

FIG. 3 is a block diagram illustrating an example video encoder that may perform the techniques of this disclosure.

FIG. 4 is a block diagram illustrating an example video decoder that may perform the techniques of this disclosure.

FIG. 5 is a flowchart illustrating an example method for encoding a current block in accordance with the techniques of this disclosure.

FIG. 6 is a flowchart illustrating an example method for decoding a current block of video data in accordance with the techniques of this disclosure.

FIG. 7 is a conceptual diagram illustrating an example of hierarchical prediction structures with GOP size equal to 16.

FIG. 8 is a conceptual diagram illustrating a convolutional neural network (CNN)-based filter with 4 layers.

FIG. 9 is a conceptual diagram illustrating a CNN-based filter with padded input samples and supplementary data.

FIG. 10 is a conceptual diagram illustrating example human vision and display capabilities.

FIG. 11 is a conceptual diagram illustrating an example color gamut.

FIG. 12 is a conceptual diagram illustrating a CNN architecture.

FIG. 13 is a conceptual diagram illustrating a spatial attention layer of an attention residual block.

FIG. 14 is a conceptual diagram illustrating an example CNN architecture.

FIG. 15 is a conceptual diagram illustrating an example CNN architecture that includes filter blocks that do not include a bypass branch around the convolution and activation layers.

FIG. 16 is a conceptual diagram illustrating an example CNN architecture.

FIG. 17 is a conceptual diagram illustrating an example multiscale feature extraction backbone network with two-component convolution.

FIG. 18 is a conceptual diagram illustrating an example unified filter with joint model (joint luma and chroma).

FIG. 19 is a conceptual diagram illustrating an example unified filter with separate luma/chroma models (luma).

FIG. 20 is a conceptual diagram illustrating an example unified filter with separate luma/chroma models (chroma).

FIG. 21 is a conceptual diagram illustrating a unified filter with luma/chroma split.

FIG. 22 is a conceptual diagram illustrating an example architecture for filtering in transform domain for the low complexity filter.

FIG. 23 is a flowchart illustrating an example operation of a video coder, in accordance with one or more techniques of this disclosure.

### DETAILED DESCRIPTION

Neural network (NN)-based intra-loop filtering (ILF) is a process in which a video encoder or a video decoder uses a neural network to apply a filter to input data, such as predicted video data, reconstructed video data, or other auxiliary video data, in order to generate filtered video data. Application of NN-based ILF may have several advantages over conventional intra-loop filtering processes, such as matrix-based adaptive loop filters (ALF), sample-adaptive offset (SAO) filtering, and deblocking filters. For example, an artificial neural network based in NN-based ILF filtering may be trained to filter reconstructed video data to generate more realistic video data and remove more artifacts than conventional filters.

However, there are several issues with NN-based ILF. For example, video data is typically produced and consumed in a red-green-blue (RGB) domain. That is, the colors of pixels are represented using a red sample, a green sample, and a blue sample. However, video encoding and video decoding typically happens in a Y′CbCr domain. In this Y′CbCr domain, the color of a pixel is represented using a luma value (Y′) and two chroma values (Cb, Cr). Thus, in order to prepare video data for encoding, a video encoder converts video data in the RGB domain to video data in the Y′CbCr domain. Conversely, in order to prepare video data for consumption after decoding encoded video data, a video decoder converts decoded video data from the Y′CbCr domain to the RGB domain. In the Y′CbCr domain, the resolution of the Y′ component may be different from the resolution of the Cb and Cr components. For example, there may be four Y′ samples for every Cb sample and every Cr sample. In other words, the Cb and Cr color components have one half of the spatial resolution of the Y′ color component. As a result of the differences in spatial resolution and other factors, application of conventional in-loop filters, such as conventional NN-based in-loop filters, to video data in the Y′CbCr domain may lead to suboptimal performance and visible artifacts, especially with high-dynamic range or wide color gamut video signals.

The techniques of this disclosure may address these problems. In accordance with an example of this disclosure, a video coder (e.g., a video encoder or a video decoder) may obtain (e.g., generate, acquire, retrieve) input data. The input data may include one or more of reconstructed video data or supplemental data (e.g., one or more of predicted video data, quantization parameter data, boundary strength data, or prediction mode data). The prediction mode data may indicate a prediction model of a block (e.g., intra mode, uni-directional inter prediction, bi-directional inter prediction, etc.). This disclosure uses the acronym IPB (Intra, Inter Prediction (uni/bi-prediction) to indicate the prediction mode. The video coder may convert the input data from an input domain to a transform domain to generate converted video data. The video coder may then apply a NN-based ILF to the converted video data to generate filtered video data. The video coder may then convert the filtered video data from the transform domain to the input domain. Converting the reconstructed video data from the input domain to the transform domain prior to application of the NN-based ILF may increase performance of a video encoder or video data, and may avoid the introduction of visible artifacts.

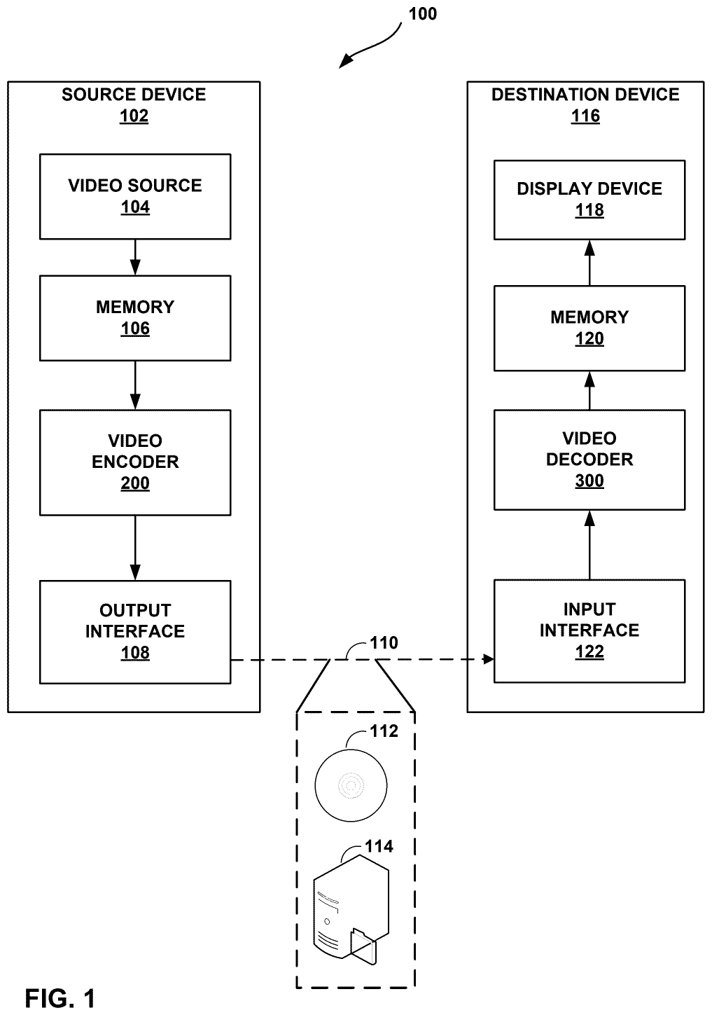

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for neural network-based in-loop filtering. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for neural network-based in-loop filtering. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). A draft of the VVC standard is described in Bross, et al. “Versatile Video Coding (Draft 10),” Joint Video Experts Team (JVET) of ITU-T SG 16 WP 3 and ISO/IEC JTC 1/SC 29/WG 11, 18th Meeting: by teleconference, 22 Jun.-1 Jul. 2020, JVET-S2001-vA (hereinafter “VVC Draft 10”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile.

The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Motion-Compensated or Inter-Picture Prediction takes advantage of the redundancy that exists between (hence “inter”) pictures of a video sequence. The block-based motion compensation, which is used in all the modern video codecs, the prediction is attained from one or more previously decoded pictures, i.e., the reference picture(s). The corresponding areas to generate the inter prediction are indicated by the motion information, including motion vectors and reference picture indices.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Intra-picture prediction exploits the spatial redundancy that exists within a picture (hence “intra”) by deriving the prediction for a block from already encoded-and-then-decoded, spatially neighboring samples (i.e., reference samples). Directional angular prediction, DC prediction, and plane or planar prediction are used in recent video codecs, including AVC, HEVC, and VVC.

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

Hybrid video coding standards apply a block transform to the prediction residual (regardless of whether it comes from inter- or intra-picture prediction). Early standard including H.261, H.262, and H.263 applied a discrete cosine transform (DCT) to residual data. In HEVC and VVC, transform kernels other than or in addition to DCT may be applied in order to account for different statistics in specific video signals.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Quantization aims to reduce the precision of an input value or a set of input values in order to decrease the amount of data needed to represent the values. In hybrid video coding, quantization is typically applied to individual transformed residual samples, i.e. to transform coefficients, resulting in integer coefficient levels. In recent video coding standards, the step size is derived from a so-called quantization parameter (QP) that controls the fidelity and bit rate. A larger step size lowers the bit rate but also deteriorates the quality, which e.g. results in video pictures exhibiting blocking artifacts and blurred details.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan.

After scanning the quantized transform coefficients to form the one-dimensional vector, video encoder 200 may entropy encode the one-dimensional vector, e.g., according to context-adaptive binary arithmetic coding (CABAC). CABAC is used in recent video codec, e.g. AVC, HEVC and VVC, due to its high efficiency. Video encoder 200 may also entropy encode values for syntax elements describing metadata associated with the encoded video data for use by video decoder 300 in decoding the video data. As part of performing CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

Video encoder 200 and video decoder 300 may apply an in-loop filter to input data, such as predicted video data, reconstructed video data, quantization parameter data, boundary strength data, IPB data, or other types of video data. In accordance with a technique of this disclosure, video encoder 200 may convert the input data from an input domain to a transform domain to generate converted video data. Video encoder 200 may then apply a NN-based ILF to the converted video data to generate filtered video data. Video encoder 200 may then convert the filtered video data from the transform domain to the input domain. Video decoder 300 may perform the same process on the reconstructed video data. Video encoder 200 and video decoder 300 may use the filtered video data in the input domain for prediction of subsequently encoded blocks of video data. In examples where the transform domain is the RGB domain and the input data includes reconstructed video data, video decoder 300 may output the filtered video data in the transform domain.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

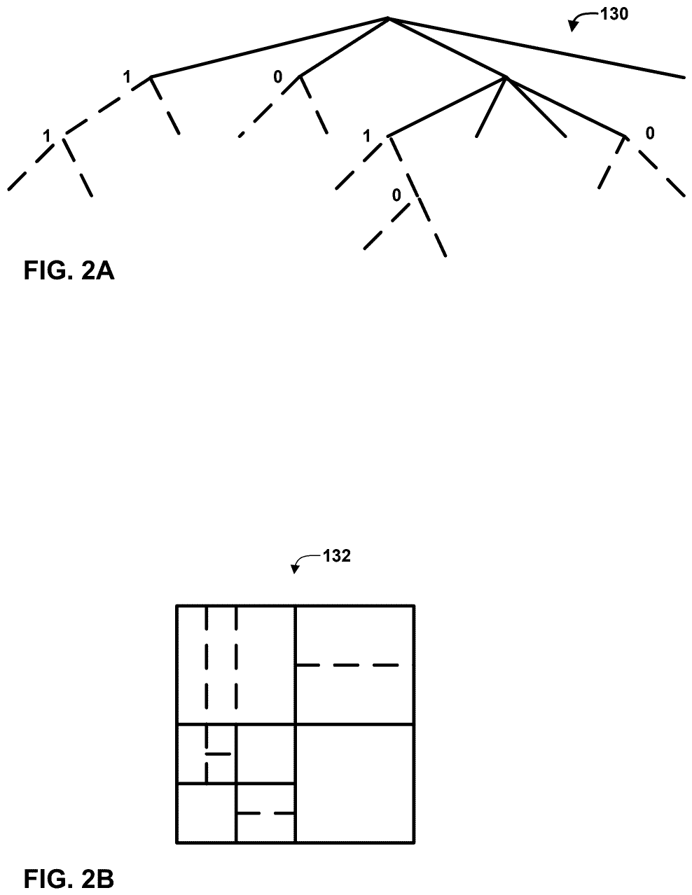

FIGS. 2A and 2B are conceptual diagrams illustrating an example quadtree binary tree (QTBT) structure 130, and a corresponding coding tree unit (CTU) 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, because quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), then the nodes can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the quadtree leaf node is 128×128, the leaf quadtree node will not be further split by the binary tree, because the size exceeds the MaxBTSize (i.e., 64×64, in this example). Otherwise, the quadtree leaf node will be further partitioned by the binary tree. Therefore, the quadtree leaf node is also the root node for the binary tree and has the binary tree depth as 0. When the binary tree depth reaches MaxBTDepth (4, in this example), no further splitting is permitted. A binary tree node having a width equal to MinBTSize (4, in this example) implies that no further vertical splitting (that is, dividing of the width) is permitted for that binary tree node. Similarly, a binary tree node having a height equal to MinBTSize implies no further horizontal splitting (that is, dividing of the height) is permitted for that binary tree node. As noted above, leaf nodes of the binary tree are referred to as CUs and are further processed according to prediction and transform without further partitioning.

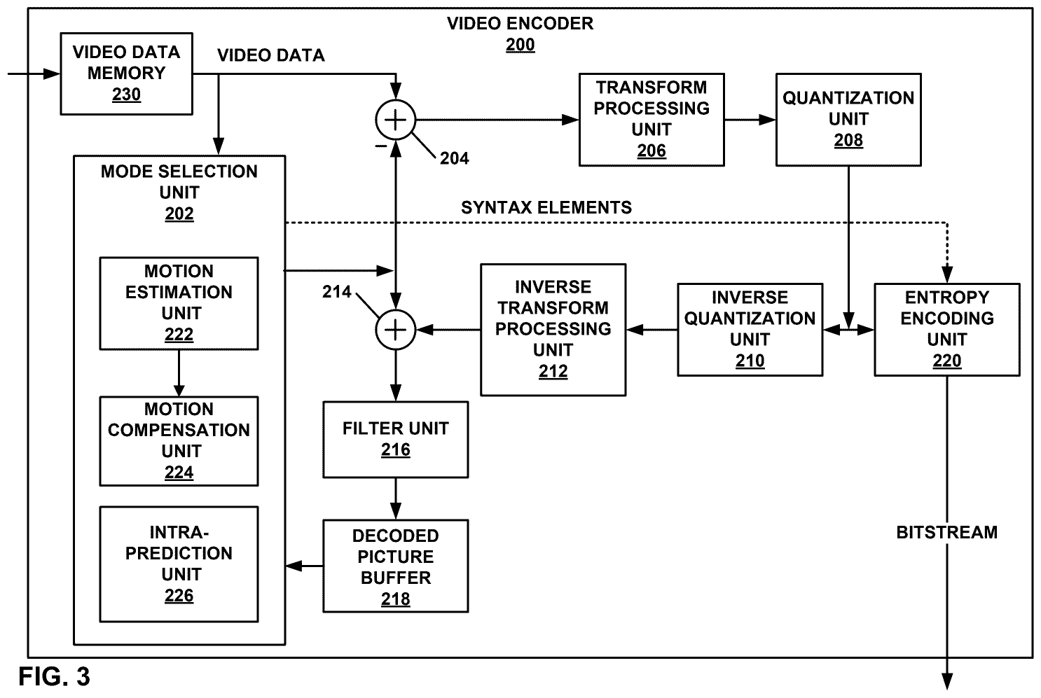

FIG. 3 is a block diagram illustrating an example video encoder 200 that may perform the techniques of this disclosure. FIG. 3 is provided for purposes of explanation and should not be considered limiting of the techniques as broadly exemplified and described in this disclosure. For purposes of explanation, this disclosure describes video encoder 200 according to the techniques of VVC (ITU-T H.266, under development), and HEVC (ITU-T H.265). However, the techniques of this disclosure may be performed by video encoding devices that are configured to other video coding standards.

In the example of FIG. 3, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 3 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUS, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. In accordance with the techniques of this disclosure, filter unit 216 may convert the reconstructed video data from an input domain to a transform domain to generate converted video data. Filter unit 216 may apply a NN-based ILF to the converted video data to generate filtered video data. Filter unit 216 may then convert the filtered video data from the transform domain to the input domain.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including one or more memories configured to store video data, and one or more processors implemented in circuitry and configured to convert video input data (e.g., reconstructed video data) from an input representation (i.e., an input domain) to a transform domain to generate converted video data; apply a neural network (NN)-based in-loop filter (ILF) to the converted video data to generate filtered video data; and convert the filtered video data to the input representation.

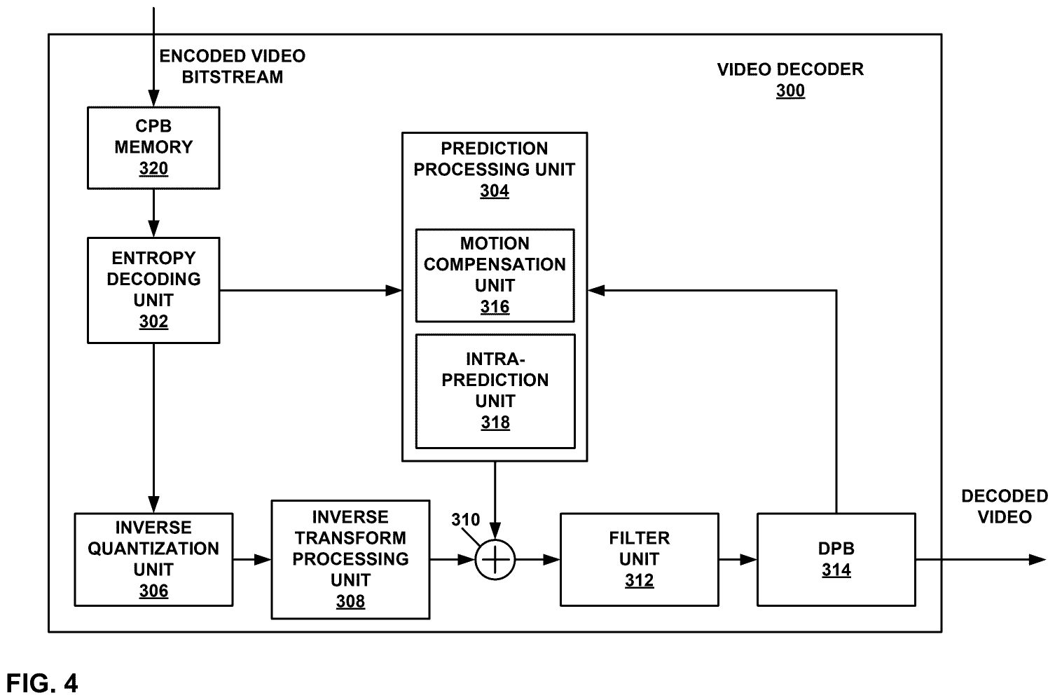

FIG. 4 is a block diagram illustrating an example video decoder 300 that may perform the techniques of this disclosure. FIG. 4 is provided for purposes of explanation and is not limiting on the techniques as broadly exemplified and described in this disclosure. For purposes of explanation, this disclosure describes video decoder 300 according to the techniques of VVC (ITU-T H.266), and HEVC (ITU-T H.265). However, the techniques of this disclosure may be performed by video coding devices that are configured to other video coding standards.

In the example of FIG. 4, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 4 are illustrated to assist with understanding the operations performed by video decoder 300. The units may be implemented as fixed-function circuits, programmable circuits, or a combination thereof. Similar to FIG. 3, fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 3).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 3). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. In accordance with the techniques of this disclosure, filter unit 312 may convert input data, such as predicted video data, reconstructed video data, or other types of video data, from an input domain to a transform domain to generate converted video data. Additionally, filter unit 312 may apply a NN-based ILF to the converted video data to generate filtered video data. Filter unit 312 may convert the filtered video data from the transform domain to the input domain.

Video decoder 300 may store the filtered reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including one or more memories configured to store video data, and one or more processors implemented in circuitry and configured to convert video input data (e.g., reconstructed video data, predicted video data, QP data, BS data, IPB data, etc.) from an input representation (i.e., an input domain) to a transform domain to generate converted video data; apply a neural network (NN)-based in-loop filter (ILF) to the converted video data to generate filtered video data; and convert the filtered video data to the input representation.

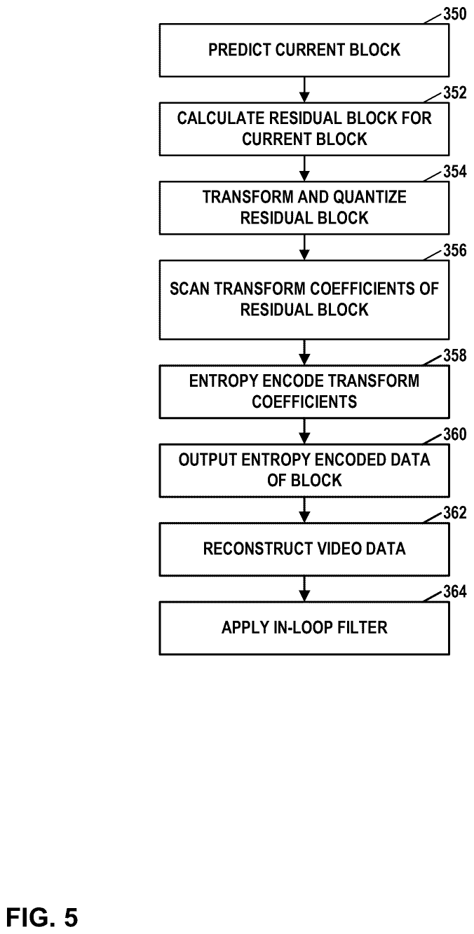

FIG. 5 is a flowchart illustrating an example method for encoding a current block in accordance with the techniques of this disclosure. The current block may comprise a current CU. Although described with respect to video encoder 200 (FIGS. 1 and 3), it should be understood that other devices may be configured to perform a method similar to that of FIG. 5.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

Additionally, video encoder 200 may reconstruct the video data (362). For example, video encoder 200 may apply inverse quantization to the quantized transform coefficients and apply an inverse transform to the inverse-quantized transform coefficients to obtain residual data. Video encoder 200 may add samples of prediction blocks to corresponding samples of the residual data to reconstruct the video data.

Video encoder 200 may apply an in-loop filter to input data, such as the reconstructed video data (364). In accordance with a technique of this disclosure, video encoder 200 may convert the input data from an input domain to a transform domain to generate converted video data. Video encoder 200 may then apply a NN-based ILF to the converted video data to generate filtered video data. Video encoder 200 may then convert the filtered video data from the transform domain to the input domain. Video encoder 200 may use the filtered video data for prediction of subsequently encoded blocks of video data.

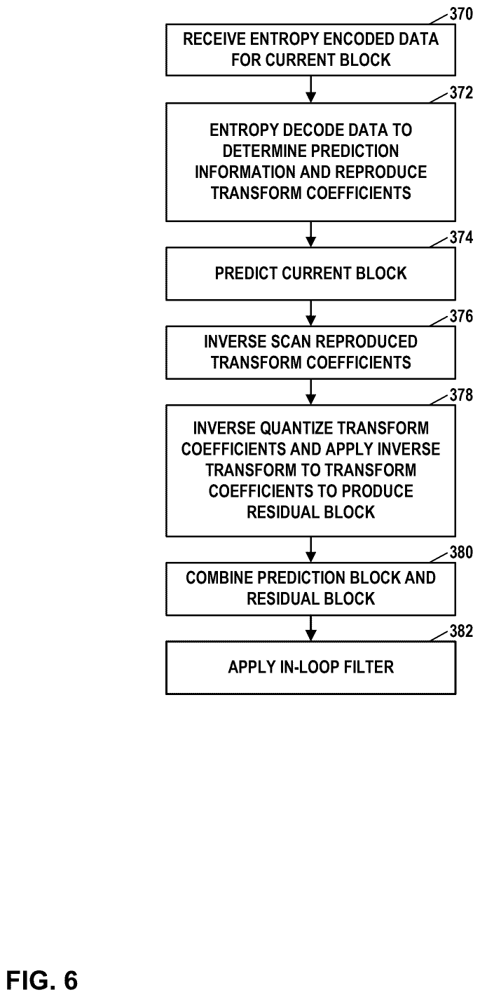

FIG. 6 is a flowchart illustrating an example method for decoding a current block of video data in accordance with the techniques of this disclosure. The current block may comprise a current CU. Although described with respect to video decoder 300 (FIGS. 1 and 4), it should be understood that other devices may be configured to perform a method similar to that of FIG. 6.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may decode the current block by combining the prediction block and the residual block (380). In other words, video decoder 300 may generate reconstructed video data based on the prediction block and the residual block. For instance, video decoder 300 may add samples of the prediction block to corresponding samples of the residual block to generate samples of the reconstructed video data.

Additionally, video decoder 300 may apply an in-loop filter to input data, such as the reconstructed video data (382). In accordance with a technique of this disclosure, video decoder 300 may convert the input data from an input domain to a transform domain to generate converted video data. Video decoder 300 may then apply a NN-based ILF to the converted video data to generate filtered video data. Video decoder 300 may then convert the filtered video data from the transform domain to the input domain. Video decoder 300 may use the filtered video data for prediction of subsequently encoded blocks of video data.

All video coding standards since H.261 have been based on the so-called hybrid video coding principle, which is illustrated in FIG. 3. The term hybrid refers to the combination of two means to reduce redundancy in the video signal, i.e., prediction and transform coding with quantization of the prediction residual. Whereas prediction and transforms reduce redundancy in the video signal by decorrelation, quantization decreases the data of the transform coefficient representation by reducing their precision, ideally by removing only irrelevant details. This hybrid video coding design principle is also used in the two most recent standards HEVC and VVC. Block partitioning is used to divide the image into smaller blocks for operation of the prediction and transform processes. The early video coding standards used a fixed block size, typically 16×16 samples. Recent standards such as HEVC and VVC employ tree-based partitioning structures to provide flexible partition.

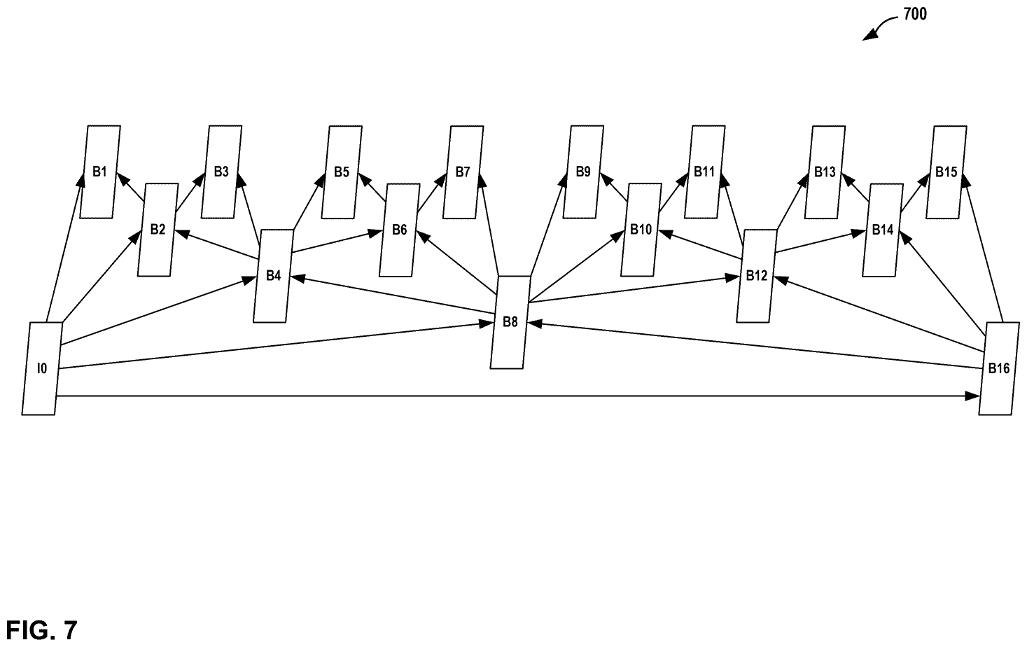

In recent video codecs, hierarchical prediction structures inside a group of pictures (GOP) is applied to improve coding efficiency. FIG. 7 is a conceptual diagram illustrating an example of a hierarchical prediction structure 700 with GOP size equal to 16. In the example of FIG. 7, each of the quadrilateral shapes correspond to a distinct picture. Arrows pointing from a first picture to a second picture indicate that decoding of the second picture depends on decoding of the first picture. For example, it may be necessary to decode pictures I0 and B2 in order to decode picture B1.

Post-loop filtering and in-loop filtering are filtering processes (or combination of such processes) that are applied to reconstructed pictures or other video data to reduce the coding artifacts. The input of the filtering process is generally the reconstructed picture, which is the combination of the reconstructed residual signal (which includes quantization error) and the prediction. As shown in FIG. 3, the reconstructed pictures after in-loop filtering are stored and used as a reference for inter-picture prediction of subsequent pictures. The coding artifacts are mostly determined by the QP. Therefore, QP information is generally used in the design of the filtering process. In HEVC, the in-loop filters include deblocking filtering and sample adaptive offset (SAO) filtering. In the VVC standard, an adaptive loop filter (ALF) was introduced as a third filter. The filtering process of ALF is shown in equation (1) below,

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 ) \qquad ( 1 )$$

In equation (1), R(i, j) is a sample at position (i, j) before application of the filtering process, R′(i, j) is the sample value at position (i, j) after filtering process, f(k, l) denotes the filter coefficients, K(x, y) is the clipping function, and c(k, l) denotes clipping parameters. The variables k and l vary between −L/2 and L/2, where L denotes the filter length. The filter length is the number of values used to determine an output value. The clipping function K(x, y)=min (y, max(−y, x)) which corresponds to the function Clip3 (−y, y, x). The clipping operation introduces non-linearity to make ALF more efficient by reducing the impact of neighbor sample values that are too different with the current sample value. In other words, the output values produced by the clipping function have discontinuous, nondifferentiable corners at the upper and lower boundaries of the clipping function. In VVC, the filtering parameters can be signalled in the bitstream, or the filtering parameters can be selected from a plurality of pre-defined filter sets. The ALF filtering process can also be summarised as following equation.

$${R}^{′} ( i , j ) = R ( i , j ) + ALF\_residual \_ouput ( R ) \qquad ( 2 )$$

Many works show that embedding neural networks into a hybrid video coding framework can improve compression efficiency. Neural networks have been used for intra prediction and inter prediction to improve the prediction efficiency. Neural network (NN)-based in-loop filtering has also been a prominent research topic in recent years. In some works, the filtering process is applied as a post-filter. In this case, the filtering process is only applied to the output picture and unfiltered pictures are used as reference pictures.

In some examples, a video coder (e.g., a video encoder or a video decoder) may apply an NN-based filter in addition to existing filters such as deblocking filter, SAO and ALF. In some examples, a video coder may apply an NN-based filter exclusively, where the NN-based filter is designed to replace all the existing filters.

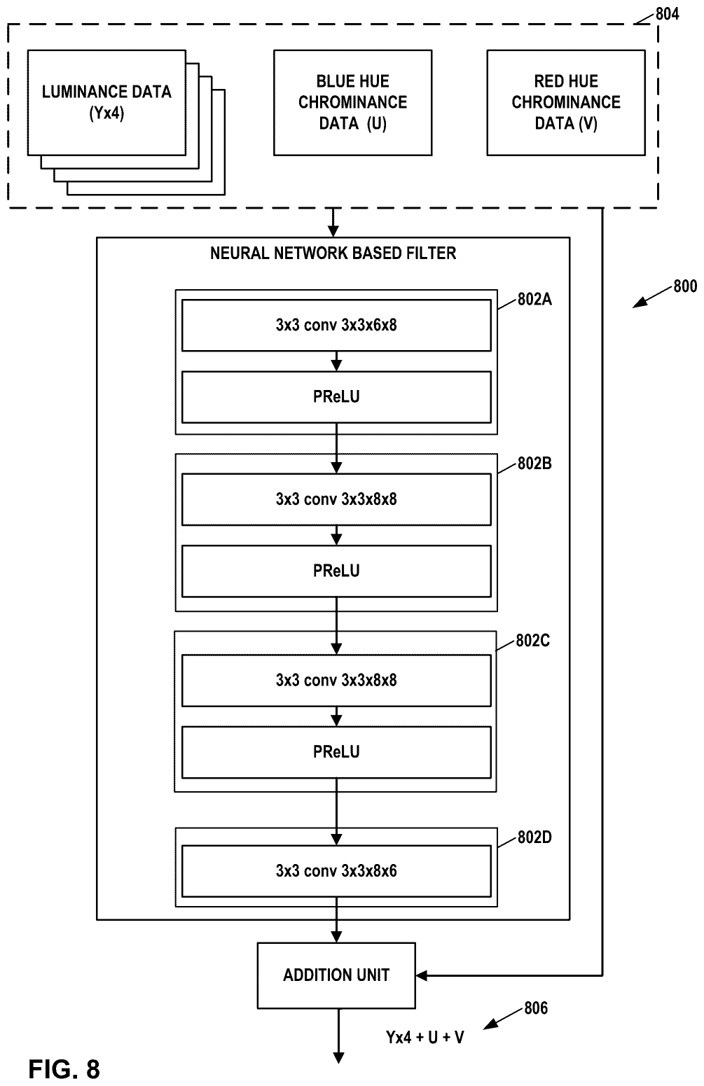

An example of an NN-based filter is shown in FIG. 8. FIG. 8 is a conceptual diagram illustrating a CNN-based filter 800 with four layers 802A, 802B, 802C, and 802D. This disclosure refers to layers 802A, 802B, 802C, and 802D collectively as “layers 802.” Each of layers 802A, 802B, and 802C includes a convolutional layer and a PreLU activation function layer. Each of the convolutional layers applies a convolution function. The hidden layers may include layers that perform convolutions, pooling layers, fully connected layers, normalization layers, and other types of layers. Layer 802D has a convolutional layer and no activation function layer. This disclosure uses a×b×c×d notation with respect with convolutional layers. In this notation, a and b represent dimensions of a kernel (i.e., a two-dimensional array of features), c represents the number of input channels per feature of the feature map, and d represents the number of output channels. Thus, in FIG. 8, the notation 3×3×6×8 in the convolutional layer of layer 802A has a 3×3 kernel (meaning that the convolutional neural network is applied to a 3×3 grid of features), each of the features having 6 input channels (e.g., 4 Y′ samples, 1 Cb sample, and 1 Cr sample), and 8 output channels. Thus, the convolution layer of layer 802A outputs 8 values.

In the example of FIG. 8, there is 4:1 relationship between luma samples and Cb or Cr chroma samples. Hence, in the example of FIG. 8, the NN-based filtering process takes the reconstructed luma and chroma samples 804, packed in a 3D volume with 6 planes (i.e., four planes of luma samples, a plane of Cb samples, and plane of Cr samples). Layers 802 output intermediate samples. The intermediate samples are residual values which are added back to the input reconstructed luma and chroma samples 804 to generate refined input samples 806. The NN-based filter may use all color components as input to exploit the cross-component correlations. The different components may share the same filters (including network structure and model parameters) or each component has its own specific filters.

The NN-based filtering process can also be generalized as shown in equation (3), below:

$${R}^{′} ( i , j ) = R ( i , j ) + NN\_filter \_residual \_ouput ( R ) \qquad ( 3 )$$

The model structure and model parameters of NN-based filter(s) can pre-defined and be stored at video encoder 200 and video decoder 300. The model structure and/or model parameters of NN-based filters can also be signalled in the bit stream.

When NN-based filtering is applied in video coding, a video coder may split the whole video signal (pixel data) into multiple processing units (e.g. 2D blocks). The video coder may process each processing unit separately or combined with other information associated with this block of pixels. The possible choices of processing units may include a frame, a slice/tile, a CTU or any pre-defined or signaled shapes and sizes.

To further improve the performance of NN-based filtering, different types of input data can be processed jointly to produce the filtered output. Input data may include, but are not limited to, reconstructed, prediction pixels, pixels after the loop filter(s), partitioning structure information, deblocking parameters (BS), QP values, slice or picture types or filters applicability or coding modes map. Input data can be provided at the different granularity. Luma reconstruction and prediction samples can be provided at the original resolution, whereas chroma samples could be provided at lower resolution, e.g., for 4:2:0 representation, or can be up-sampled to the luma resolution to achieve per-pixel representation. Similarly, QP, BS, partitioning or coding mode information can be provided at lower resolution, including cases with a single value per frame/slice or processing block (e.g., QP), or this value can be expanded (replicated) to achieve per-pixel representation.

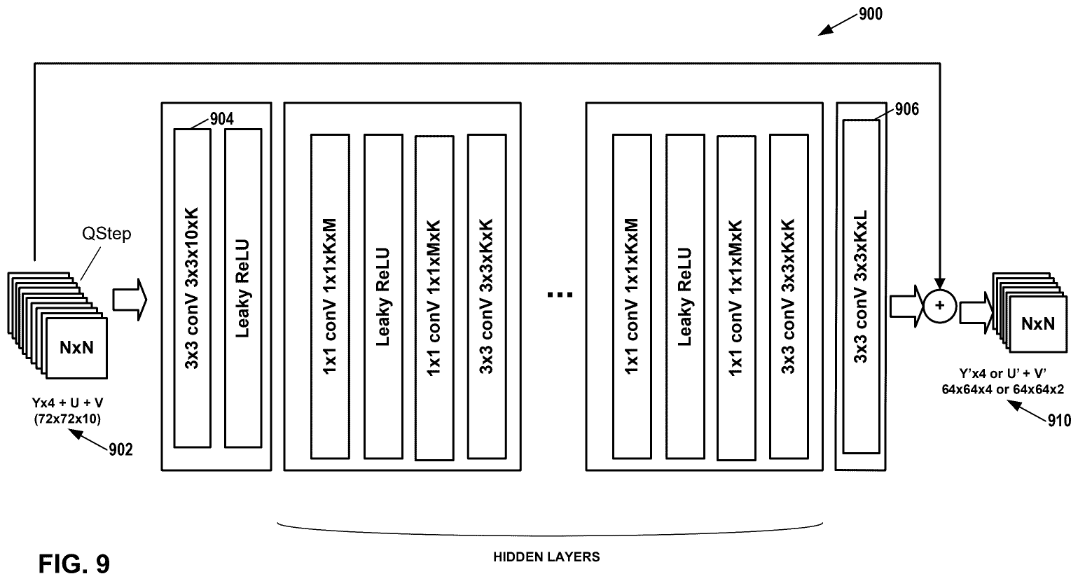

FIG. 9 is a conceptual diagram illustrating a CNN-based filter 900 with padded input samples and supplementary data. An example of an architecture utilizing supplementary data is shown in FIG. 9. Pixels of a processing block 902 (4 subblocks of interlaced Luma samples plane and associated Cb and Cr planes) are combined with supplementary information such as QP steps and BS. The area of a processing pixel (i.e., a block of pixels being processed) is extended with 4 padded pixels from each side. The total size of the processing volume is (4+64+4)×(4+64+4)×(4 Y+2UV+1QP+3BS), i.e., 72×72×10. In other words, input to CNN-based filter 900 is a 64×64 block of pixels padded with 4 pixels above and below, left and right (i.e., 4+64+4). Each pixel is associated with 10 channels, i.e., 4 Y samples and 2 UV samples per pixel, plus 1 QP, plus 3 boundary strength values. A first convolutional layer 904 is applied to 3×3 arrays of pixels in the input, resulting in K values for each of the 3×3 arrays. A final convolutional layer 906 outputs residual video data that is added to the original video data to obtain filtered video data 910.

To further improve the performance of NN-based filtering, multi-mode solutions can be designed. For example, for each processing unit, video encoder 200 may select among a set of modes based on rate-distortion optimization and the choice can be signaled in the bitstream. The set of modes may include different NN models, different values that used as the input information of the NN models, etc. Video decoder 300 may use the selected mode for NN-based filtering. As an example, a NN-based filtering solution was previously proposed that created multiple modes based on a single NN model by using different QP values as input of the NN model for different modes.

Next generation video applications are anticipated to operate with video data representing captured scenery with high dynamic range (HDR) and wide color gamut (WCG) representation and sourced from the dedicated content production software, such as computer-generated imagery (CGI), or camera captured content.

Dynamic range is typically defined as the ratio between the minimum and maximum brightness of the video signal. It is also measured in terms of ‘f-stop’, where one f-stop corresponds to a doubling of the signal dynamic range. In MPEG's definition, the High Dynamic Range content is such content that features brightness variation with more than 16 f-stops. In some terms, levels between 10 and 16 f-stops are considered as intermediate dynamic range, but it is considered HDR in other definitions. At the same time, human visual system is capable for perceiving much larger dynamic range, however it includes adaptation mechanism to narrow so called simultaneous range.

Current video application and services are regulated by Rec.709 and provide SDR, typically supporting a range of brightness (or luminance) of around 0.1 to 100 candelas (cd) per m2 (often referred to as “nits”), leading to less than 10 f-stops. The next generation video services are expected to provide dynamic range of up-to 16 f-stops and although detailed specification is currently under development, some initial parameters of have been specified in SMPTE-2084 and Rec.2020.

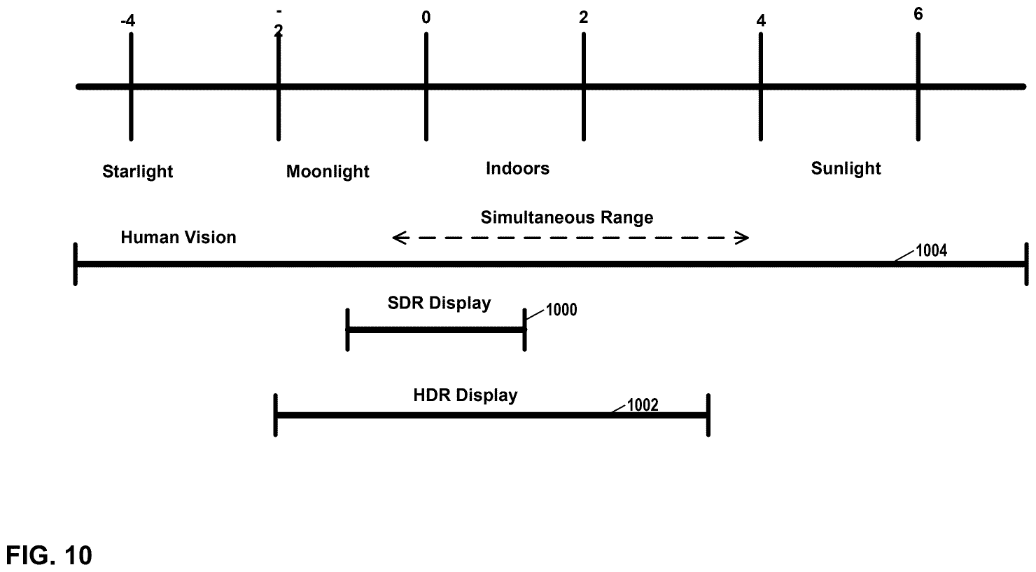

A visualization of dynamic range provided by SDR 1000 of HDTV, expected HDR 1002 of ultrahigh definition television (UHDTV) and human visual system dynamic range 1004 is shown in FIG. 10. FIG. 10 is a conceptual diagram illustrating example human vision and display capabilities.

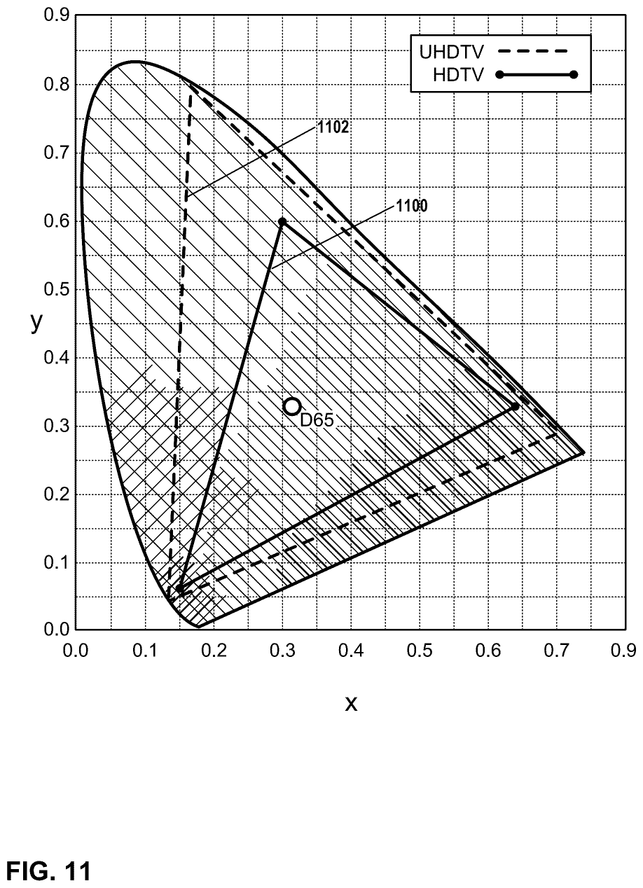

Another aspect for a more realistic video experience besides HDR is the color dimension, which is conventionally defined by the color gamut. FIG. 11 is a conceptual diagram illustrating an example color gamut. FIG. 11 visualizes SDR color gamut 1100 (triangle based on the BT.709 color red, green and blue color primaries), and the wider color gamut that for UHDTV (triangle based on the BT.2020 color red, green and blue color primaries). The figure also depicts the so-called spectrum locus (delimited by the tongue-shaped area), representing limits of the natural colors. As illustrated by FIG. 11, moving from BT.709 to BT.2020 color primaries aims to provide UHDTV services with about 70% more colors. The point, D65, specifies the white color for given specifications. A few examples of color gamut specification are shown in Table 1, below.

TABLE 1
Colorimetry parameters for selected color spaces
RGB color space parameters

| Color | White point | | Primary colors | | | | | |
|---|---|---|---|---|---|---|---|---|
| space | x_{W} | y_{W} | x_{R} | y_{R} | x_{G} | y_{G} | x_{B} | y_{B} |
| DCI-P3 | 0.314 | 0.351 | 0.680 | 0.320 | 0.265 | 0.690 | 0.150 | 0.060 |
| ITU-R | 0.3127 | 0.3290 | 0.64 | 0.33 | 0.30 | 0.60 | 0.15 | 0.06 |
| BT.709 | | | | | | | | |
| ITU-R | 0.3127 | 0.3290 | 0.708 | 0.292 | 0.170 | 0.797 | 0.131 | 0.046 |
| BT.2020 | | | | | | | | |

RGB data is typically utilized as input, since it is produced by image capturing sensors. However, this color space has high redundancy among its components and is not optimal for compact representation. To achieve a more compact and more robust representation, RGB components are typically converted to a more uncorrelated color space more suitable for compression, such as YCbCr. This color space separates the brightness in the form of luminance and color information in different un-correlated components.

For modern video coding systems, the typically used colour space is YCbCr, as specified in ITU-R BT.709 or ITU-R BT.709. The YCbCr colour space in BT.709 standard specifies the following conversion process from R′G′B′ to Y′CbCr (non-constant luminance representation):

$${Y}^{′} = 0.2126 * {R}^{′} + 0.7152 * {G}^{′} + 0.0722 * {B}^{′} \qquad ( 3 )$$

$$Cb = \frac{{B}^{′} - {Y}^{′}}{1.8556}$$

$$Cr = \frac{{R}^{′} - {Y}^{′}}{1.5748}$$

The equations above can also be implemented using the following approximate conversion that avoids the division for the Cb and Cr components:

$${Y}^{′} = 0.2126 * {R}^{′} + 0.7152 * {G}^{′} + 0.0722 * {B}^{′} \qquad ( 4 )$$

$$Cb = - 0.1 \; 14572 * {R}^{′} - 0.385428 * {G}^{′} + 0.5 * {B}^{′}$$

$$Cr = 0.5 * {R}^{′} - 0.454153 * {G}^{′} - 0.045847 * {B}^{′}$$

The ITU-R BT.2020 standard specifies the following conversion process from R′G′B′ to Y′CbCr (non-constant luminance representation):

$${Y}^{′} = 0.2627 * {R}^{′} + 0.678 * {G}^{′} + 0.0593 * {B}^{′} \qquad ( 5 )$$

$$Cb = \frac{{B}^{′} - {Y}^{′}}{1.8814}$$

$$Cr = \frac{{R}^{′} - {Y}^{′}}{1.4746}$$

Equations (5) above can also be implemented using the following approximate conversion that avoids the division for the Cb and Cr components:

$${Y}^{′} = 0.2627 * {R}^{′} + 0.678 * {G}^{′} + 0.0593 * {B}^{′} \qquad ( 6 )$$

$$Cb = - 0.13963 * {R}^{′} - 0.36037 * {G}^{′} + 0.5 * {B}^{′}$$

$$Cr = 0.5 * {R}^{′} - 0.459786 * {G}^{′} - 0.040214 * {B}^{′}$$

It should be noted that both color spaces remain normalized. Therefore, for the input values normalized in the range 0 . . . 1 the resulting values will be mapped to the range 0 . . . 1. Generally, color transforms implemented with floating point accuracy provide perfect reconstruction, thus this process is lossless.

This following section presents examples of CNN In-Loop Filtering (ILF) architecture that are being actively developed in JVET.

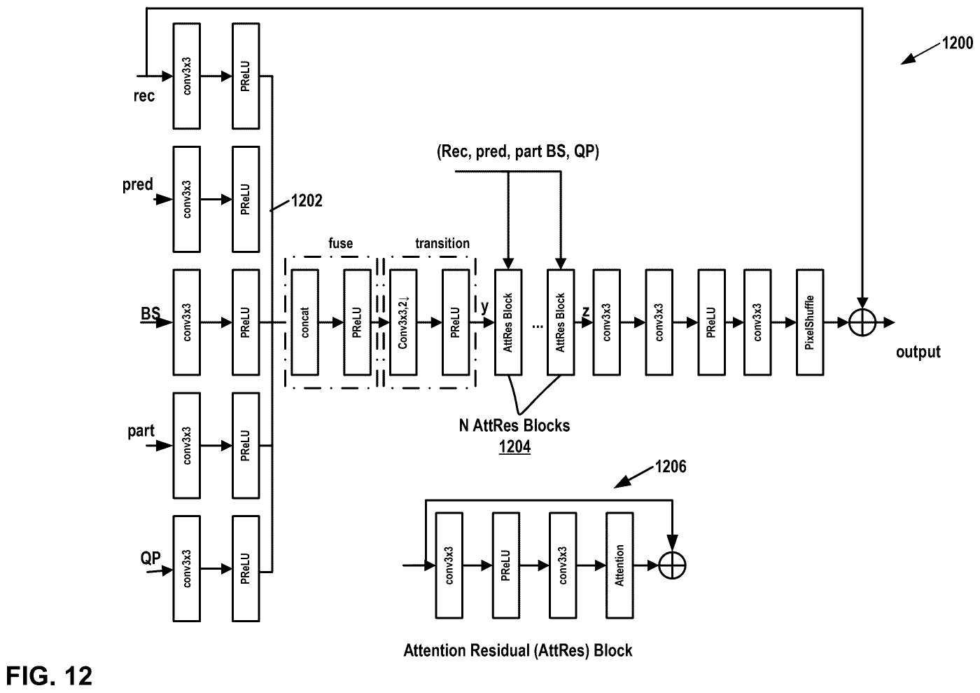

FIG. 12 is a conceptual diagram illustrating a CNN architecture 1200. In Y. Li et al “EE1-1.7: Combined Test of EE1-1.6 and EE1-1.3,” JVET-Z0113, April 2022 (hereinafter, JVET-Z0113) an NN based filtering solution with multiple modes was proposed. An architecture 1200 of the network is shown in FIG. 12. In the first part (FIG. 12), the different input data types (i.e., reconstructed video data (rec), predicted video data (pred), boundary strength values (BS), partitioning data (part), and quantization parameter (QP) data) are convolved with number of kernels size of 3×3 (represented in FIG. 12 as rectangles labeled conv3×3) to produce feature maps, undergo activation (represented in FIG. 12 as rectangles labeled PRELU, denoting the parameterized rectilinear linear unit activation function). The partitioning data indicates how a block is partitioned. The label Conv 3×3,2↓ indicates down-sampling of 2 by using stride 2. The results 1202 for each data type are concatenated, fused, and subsampled once to create an output y. The number of feature maps used in JVET-Z0113 is 96. This output is then fed through N=8 attention residual blocks 1204 (AttRes Block). The structure of an example attention residual block 1206 is further shown in FIG. 12. As shown, attention residual block 1206 includes a first convolution layer, an activation layer, a second convolution layer, and a spatial attention layer.

The output from the last attention residual block z is fed into the last part of the network, which includes a first set of convolution layers, an activation layer, an additional convolution layer, and a pixel shuffle layer. The pixel shuffle layer rearranges elements in a tensor to perform upsampling, e.g., to increase spatial resolution. In the context of architecture 1200 and other architectures described in this disclosure, the pixel shuffle layer performs upsampling by converting the data from channel domain to spatial domain. Output of the pixel shuffle layer is added to the reconstructed video data to generate the output of CNN architecture 1200.

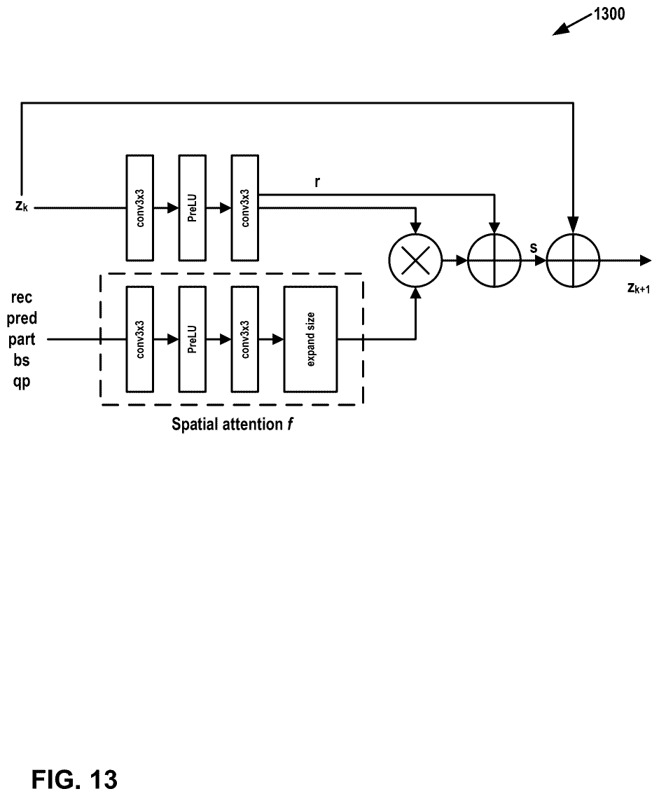

FIG. 13 is a conceptual diagram illustrating a spatial attention layer 1300 of an attention residual block. FIG. 13 shows that attention may be performed using a element-wise multiplication from the input features to the extracted features of each backbone blocks.

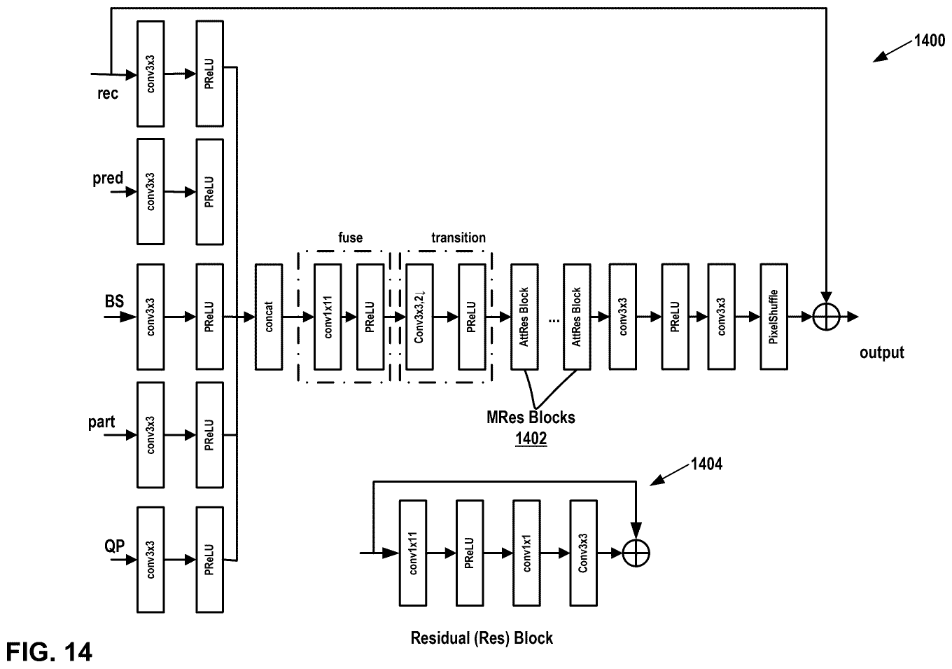

In S. Eadie, M. Coban, M. Karczewicz, EE1-1.9: Reduced complexity CNN-based in-loop filtering, JVET-AC0155, January 2023 (hereinafter, “JVET-AC0155”), an alternative design of NN architecture was proposed. It was proposed to use larger number of low complexity residual blocks in the backbone of the JVET-Z0113 CNN filter along with reduced number of channels (feature maps) and removal of the attention modules. The proposed CNN filtering structure (for Luma filtering) is shown in FIG. 14. FIG. 14 is a conceptual diagram illustrating an example CNN-architecture 1400.

In CNN-architecture 1400, the quantity of residual blocks used is M=24. The quantity of feature maps (convolutions) is reduced to 64. CNN-architecture 1400 includes residual blocks (ResBlocks) 1402. In ResBlocks 1402, the quantity of channels firstly goes up to 160 before the activation layer, and then goes down to 64 after the activation layer. Residual block 1404 is an example of residual blocks 1402. The number of residual blocks and channels can be configured differently (M set to another value and the number of channels in the residual block can be set to a number different than 160) for different performance-complexity trade-offs. Chroma filtering follows the concept in JVET-Z0113 with the above modifications to its backbone for processing of chroma channels.

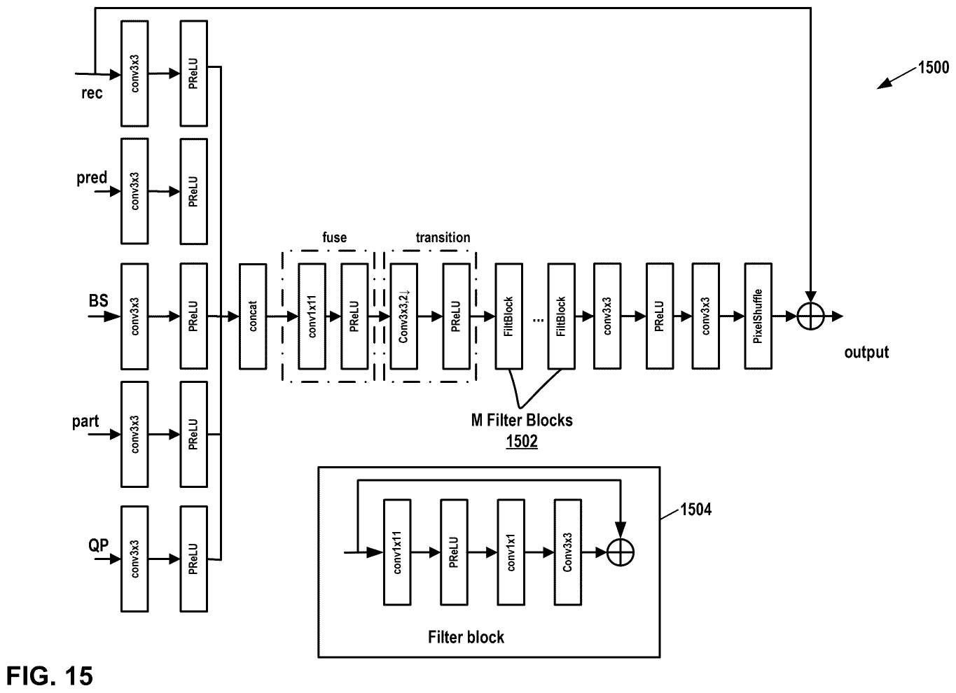

In a further modification, the bypass branch around convolution and activation layers in the residual block in the previous solution is removed. FIG. 15 is a conceptual diagram illustrating an example CNN architecture 1500 that includes filter blocks 1502 that do not include a bypass branch around the convolution and activation layers. Thus, in the example of FIG. 15, a filter block 1504 may have the same layers as residual block 1404 but does not include the bypass branch. The number of channels and number of filter blocks can be configurable, for example, 64 channels, 24 filter blocks, with 160 channels before and after the activation, which results in the complexity of the network is 605.93 kMAC and the number of parameters is 1.5M for the intra luma model.

Further complexity reduction of CCN ILF architecture is achieved with utilization of the separable convolution in place of 2D convolutions (3×3), e.g., as described in U.S. provisional patent application 63/485,862, filed Feb. 17, 2023, converted to U.S. patent application Ser. No. 18/442,955, and published as U.S. patent publication 2024/0283925. In Seregin et al., “EE2: Summary report of exploration experiment on enhanced compression beyond VVC capability” JVET-AD0023, (hereinafter, “JVET-AD0023”), EE1 test 1.3.5, a low-rank convolution approximation decomposes a 3×3×M×N convolution into a pixel-wise convolution (1×1×M×R), two separable convolutions (3×1×R×R, 1×3×R×R) and another pixel-wise convolution (1×1×R×N) was applied to the residual block of the architecture described in JVET-AC0155. Here, R is the rank of the approximation, and can ablate the performance/complexity of the approximation.

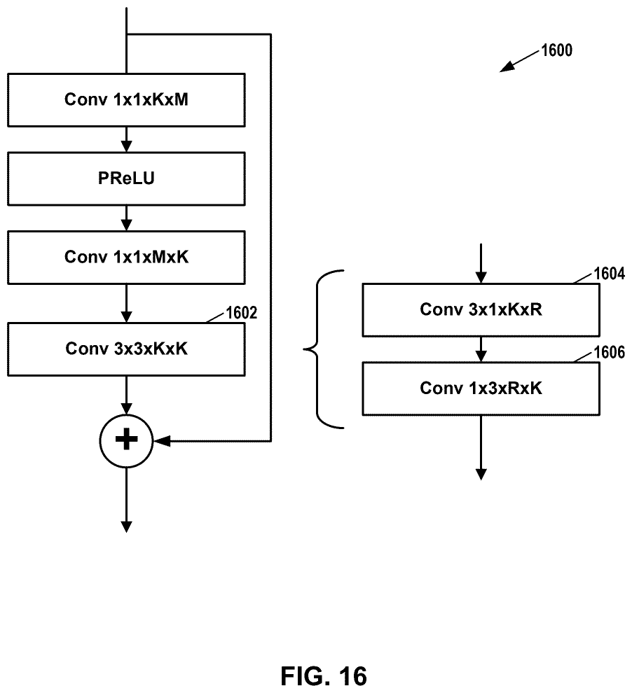

In one example, the CNN architecture 1500 of FIG. 15, with decomposition illustrated in FIG. 16, is implemented with parameters K=64, M=160 and R=51, and total number of 24 residual blocks results in the complexity of the network is 356.43 kMAC and the number of parameters is 1.07M for the intra luma model. K and M are channels (input or output). R is the rank of the decomposition. FIG. 16 is a conceptual diagram illustrating an example CNN architecture 1600. In the example of FIG. 16, the last convolutional layer 1602 of filter block 1504 includes a first convolutional layer 1604 and a second convolutional layer 1606.

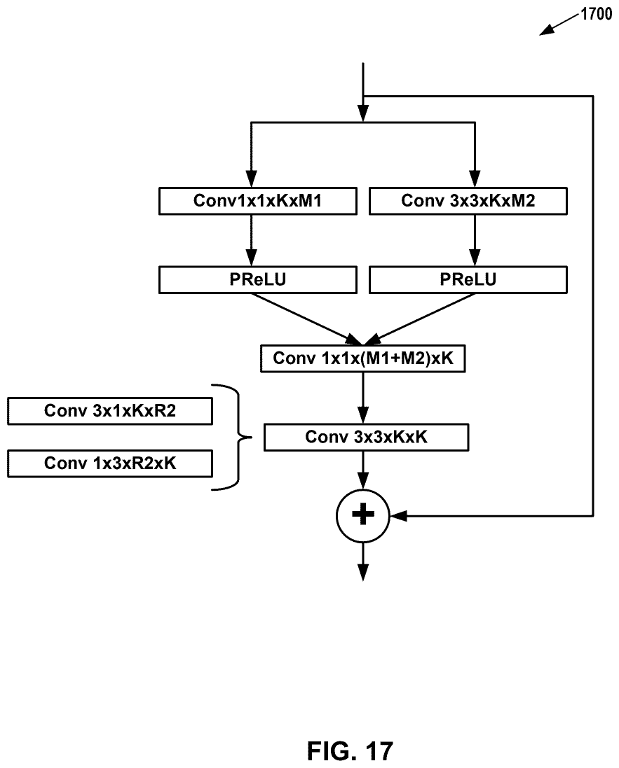

A multiscale feature extraction with a two-component convolution network is proposed in Y. Li, S. Eadie, D. Rusanovskyy, M. Karczewicz, EE1-Related: Combination test of EE1-1.3.5 and multi-scale component of EE1-1.6, JVET-AD0211, April 2023 (hereinafter, “JVET-AD0211”), which is illustrated in FIG. 17, the 3×3 convolutions are decomposed into a 3×1×C1×R convolution and followed by a 1×3×R×C2 convolution, where C1 and C2 are the number of input and output channels, respectively, and R is the rank of the approximation. FIG. 17 is a conceptual diagram illustrating an example multiscale feature extraction backbone network 1700 with two-component convolution. The parameter R can be made proportional to R=C1×C2/(C1+C2) and controls the complexity of the approximation.

As an example, the architecture illustrated in FIG. 17 can be implemented with parameters R1=8, R2=44, M1=160 and M2=16, and total number of 24 residual blocks, the complexity of the network will be 358.43 kMAC and the number of parameters is 1.07M for the intra luma model. M1 and M2 are input channels and R is the rank of the decomposition.

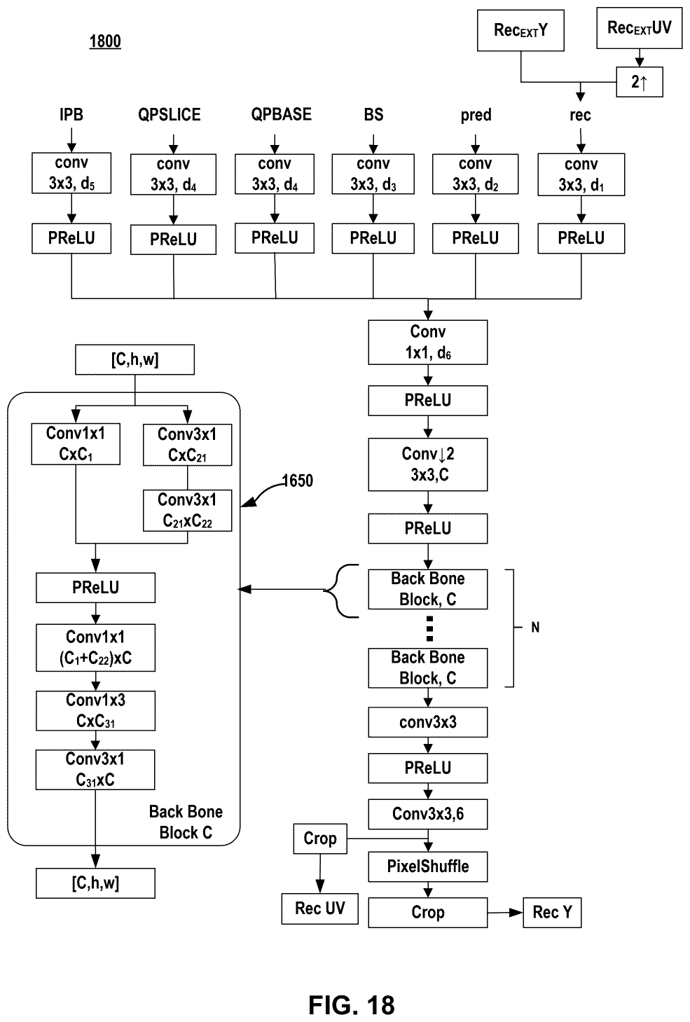

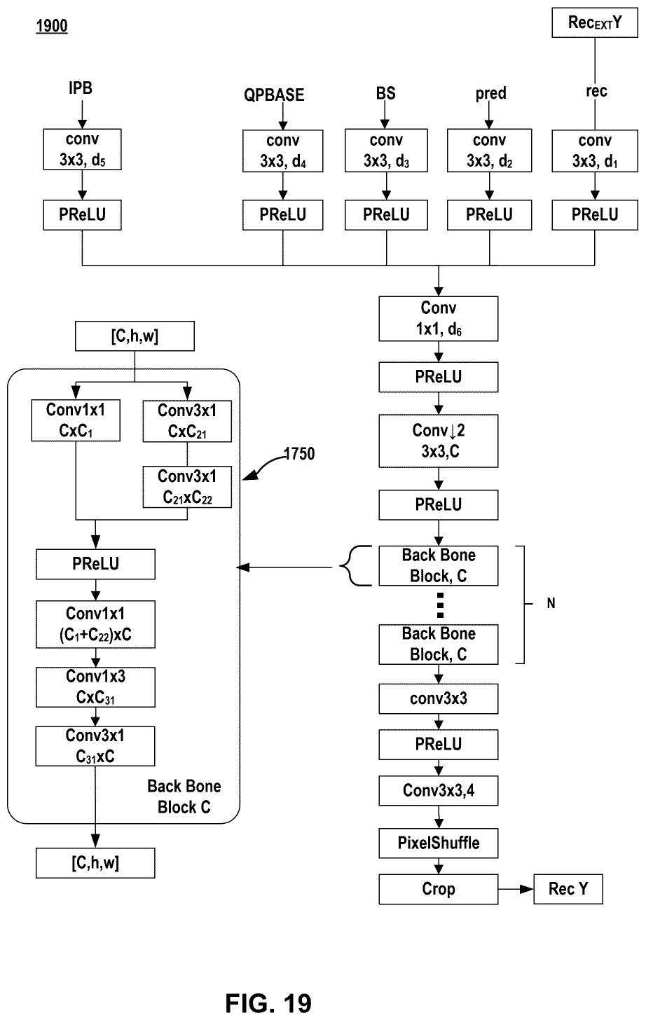

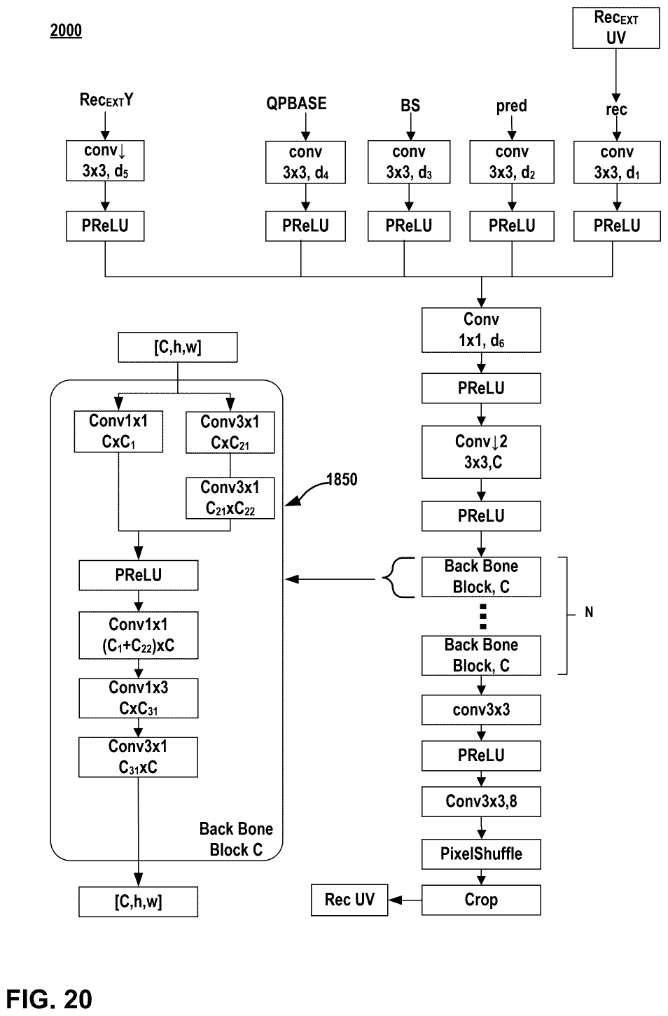

The multiscale feature extraction backbone with the two-component decomposition has been integrated into the unified model in EE. In addition, the specification from the EE contains two versions of the model, which are 1) a unified model for joined luma and chroma, see FIGS. 18, and 2) separate models for luma and chroma, respectively, see FIG. 19 and FIG. 20. FIG. 18 is a conceptual diagram illustrating an example unified filter with joint model 1800 (joint luma and chroma). In the example of FIG. 18, inputs to joint model 1800 include reconstructed Y samples (Rec_{EXT}Y), reconstructed UV samples (Rec_{EXT}UV), prediction modes (IPB) that indicates the prediction mode of each block (e.g., intra predicted, inter uni-predicted or bi-predicted), a slice QP (QPSLICE), a base QP (QBPBASE), a boundary strength (BS), and predicted samples (pred). Rec_{EXT} is reconstructed UV data. 3×3 means convolutional kernel 3×3. d₁, d₂, . . . , d₅ are the output channels. In the example of FIG. 18 assumes that the 4:2:0 format is used. Accordingly, the reconstructed UV samples are upsampled by a factor of 2 (i.e., 21) to form reconstructed samples (rec). Furthermore, in the example of FIG. 18, parameters d₁=192, d₂=32, d₃=16, d₄=16, d₅=16, C=64, C₁=160, C₂₁=32, C₂₂=32, C₃₁=64, N=24, and d₆=48. FIG. 19 is a conceptual diagram illustrating an example unified filter with separate luma/chroma models 1900 (luma). FIG. 20 is a conceptual diagram illustrating an example unified filter with separate luma/chroma models 2000 (chroma). In the example of FIG. 19, parameters d₁=192, d₂=32, d₃=16, d₄=16, d₅=16, C=64, C₁=160, C₂₁=32, C₂₂=32, C₃₁=64, N=20, and d₆=48. In the example of FIG. 20, parameters d₁=192, d₂=32, d₃=16, d₄=16, d₅=16, C=64, C₁=160, C₂₁=160, C₂₂=32, C₃₁=64, N=20, and d₆=48.

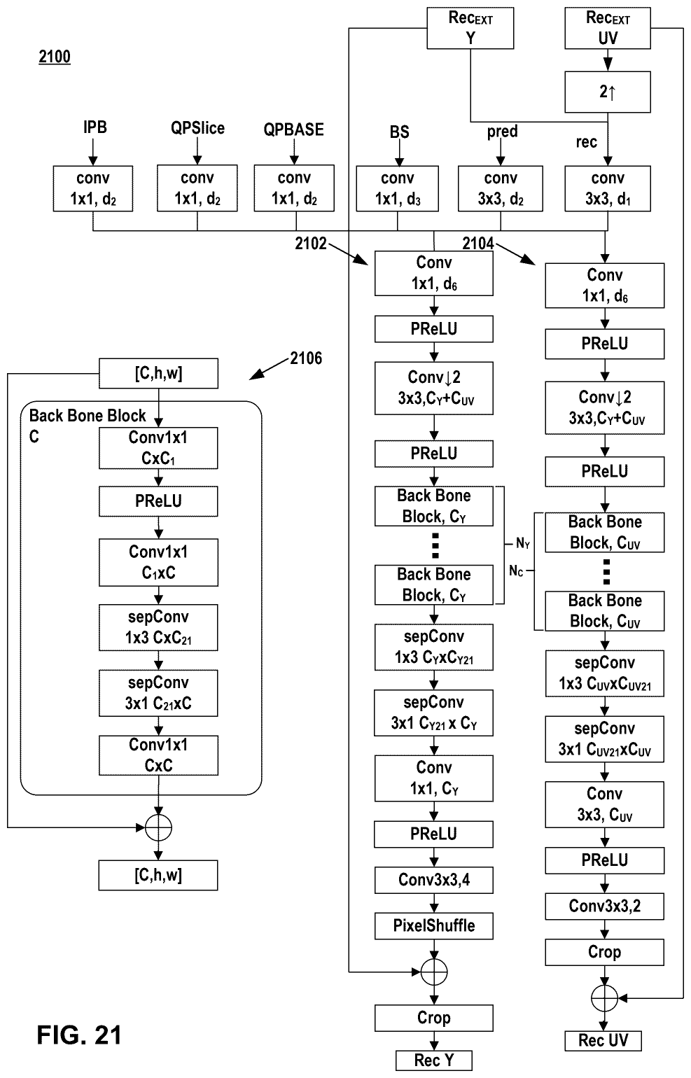

A CCN ILF filter architecture with luma/chroma split was proposed in Rusanovskyy et al., “Unified LOP filter design, training procedure and filter usage”, JVET-AE0281 (hereinafter, “JVET-AE0281”). Separate processing branches for luma and chroma allows independent training of the NN weights to target component and a degree of complexity-performance tradeoff optimization. In the filter architecture shown in FIG. 21, chroma branch can employ smaller number of the BB, e.g., N_{c}<N_{y} or reduced number of channels, e.g., Cᵤᵥ<Cy or Cᵤᵥ₂₁<C_{y21}. FIG. 21 is a conceptual diagram illustrating a unified filter 2100 with luma/chroma split. As shown in FIG. 21, luma samples are processed in a first path 2102 and chroma samples are processed in a second path 2104. The back bone blocks of both the first path 2102 and the second path 2104 may have the same structure 2106. In the example of FIG. 21, the parameters may be defined as shown in the following tables.

### Headblock Parameters

| | |
|---|---|
| d1 | 12 |
| d2 | 8 |
| d3 | 4 |
| d4 | 2 |
| d5 | 2 |
| d6 | 24 |

### Backbone Parameters

| | Luma | Chroma |
|---|---|---|
| N | 12 | 6 |
| C | 16 | 16 |
| C1 | 64 | 48 |
| C21 | 16 | 16 |

Video content production, by the means of CGI or camera sensors, as well as video content consumption (through displays) is typically conducted in the RGB domain, with imagery quality being controlled for each color component. Video compression, in contrast, is being typically conducted in the Y′CbCr domain, with 4:2:0 chroma representation. In such a format, Luma is being represented in full resolution, whereas two differentiational color components (Cb and Cr) are represented in half spatial resolution.

It is known that color space conversion (RGB to Y′CbCr and back), chroma down and up-sampling, and as well as processing conducted in the luma and chroma components independently may result in suboptimal performance, or quality degradation in the RGB domain. It has been observed that, especially due to the nonlinear characteristics of the Y′CbCr representation (electrooptical transfer function (EOTF)) and its effect on quantization, special caution needs to be exercised when selecting the filter coefficients of such a resampling filter, in order to mitigate chroma “leakage.” Conventional filters, such as linear filters, that are commonly used for down-conversion of SDR chroma signals may potentially result in visual artefacts when applied to HDR/WCG signals.

In application to enhanced filtering, such as NN-based ILF, it may be suboptimal to perform the filtering on Y and UV channel together, with non-optimal RGB-Y′CbCr conversion, partially because the Y and UV data exhibit different distributions and may not be suitable for the filters to generalize on both distributions.

To address the problem described above, the input YUV video frames can be transformed, e.g., into non-YUV color space, e.g., RGB, or in a transform domain, so that the distribution of the signals in the said domain is beneficial to the filtering. Thereafter, the filtering process is applied in the transform domain. At the end of the filtering process, the transformed signals are inverse transformed back to the input representation, e.g., YUV domain.

In one example, the across-component color space conversion can be utilized as the transform. For instance, the YUV inputs are converted to RGB domain by using the method defined in the BT.709 system, and the conversion from RGB to YUV, and from YUV to RGB are performed with the following matrix multiplications, respectively:

$$[ \begin{matrix}Y \\ U \\ V\end{matrix} ] = [ \begin{matrix}0.2126 & 0.7152 & 0.0722 \\ - 0.09991 & - 0.33609 & 0.436 \\ 0.615 & - 0.55861 & - 0.05639\end{matrix} ] [ \begin{matrix}R \\ G \\ B\end{matrix} ]$$

$$[ \begin{matrix}R \\ G \\ B\end{matrix} ] = [ \begin{matrix}1 & 0 & 1.28033 \\ 1 & - 0.21482 & 0.38059 \\ 1 & 2.12798 & 0\end{matrix} ] [ \begin{matrix}Y \\ U \\ V\end{matrix} ]$$

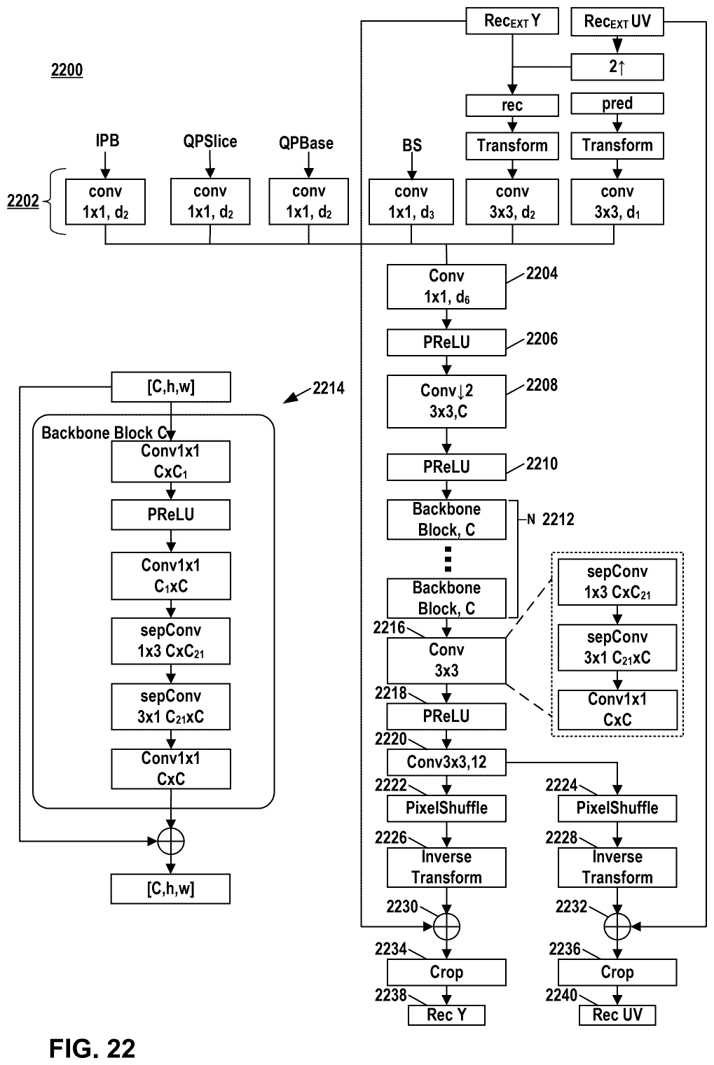

An example of the filtering process with the conversion is shown in FIG. 22 without input down-sampling for the low complexity filter. FIG. 22 is a conceptual diagram illustrating an example architecture 2200 for filtering in a transform domain for the low complexity filter. In the case of converting from the RGB domain to the YUV420 domain, an average pooling can be conducted on UV channels of the YUV444 domain to produce the required sub-sampling. In the YUV420 domain, the U and V samples are downsampled by half in both the horizontal and vertical directions. In the YUV444 domain, the U and V samples are not down-sampled relative to Y samples.

In the example of FIG. 22, inputs to architecture 2200 include reconstructed Y samples (Rec_{EXT}Y), reconstructed UV samples (Rec_{EXT}UV), IPB data, a slice QP (QPSlice), a base QP (QPBase), and a boundary strength (BS) value. Rec_{EXT}UV is extended/padded reconstructed UV data. Rec_{EXT}Y is extended/padded reconstructed Y data. Rec_{EXT}UV is upsampled (2↑) so that Y and UV samples have the same spatial resolution. Rec_{EXT}Y and the upsampled Rec_{EXT}UV are merged to form reconstructed video data (rec). A transform (transform) is then applied to the reconstructed video data to generate transform-domain reconstructed video data. The transform converts the reconstructed video data from a first domain to a second domain. For example, the transform may convert the reconstructed video data from a Y′CbCr domain to an RGB domain. The transform is also applied to predicted video data (pred) to generate transform-domain predicted video data. A video coder (e.g., video encoder 200 or video decoder 300) may use intra prediction, inter prediction, or another form of prediction to generate predicted video data. Respective convolutional layers 2202 are applied to IPB, QPSlice, QPBase, BS, the transform-domain reconstructed video data, and the transform-domain predicted video data. In the example of FIG. 22, the parameters may have the following values: d₁=12, d₂=8, d₃=4, d₄=2, d₅=2, C=24, C₁=72, C₂₁=24, N=11, and d₆=24.

Furthermore, as shown in FIG. 22, outputs of convolutional layers 2202 are concatenated and a convolutional layer 2204 is applied, followed by a PRELU activation layer 2206, a down-sampling convolutional layer 2208, another PRELU activation layer 2210, and a set of N back bone blocks 2212. Each of back bone blocks 2212 has a structure 2214 as further shown in FIG. 22. That is, input to an individual back bone block (i.e., a 3-dimensional matrix [C, h, w], where C indicates the number of channels, h indicates height of the matrix, and w indicates width of the matrix) is passes through a series of convolutional layers, activation function layers, sepConv layers, and a final convolutional layer. sepConv is to separate a 3×3 convolution to 3×1 and 1×3 convolution for example. Output of the final convolutional layer is added to the initial input of the backbone block to form an output matrix.

A convolutional layer 2216 is applied to the output of the final backbone block. Convolutional layer 2216 includes two sepConv layers, followed by a convolutional layer. An activation layer 2218 is applied to the output of convolutional layer 2216, followed by another convolutional layer 2220. Pixel shuffle 2222 re-arranges the Y data of pixels from the channel domain to the spatial domain. Inverse transform 2226 converts the Y data back to the state before the Y data was transformed. Pixel shuffle 2224 re-arranges the UV data of pixels from the channel domain to the spatial domain. Inverse transform 2228 converts the UV data back to the state before the UV data was transformed. Output of inverse transform 2226 (e.g., luma samples in the initial domain, e.g., the Y′CbCr domain) is added to the reconstructed Y samples (2230) and cropped (2234), thereby generating filtered reconstructed Y samples 2238. Output of inverse transform 2228 (e.g., chroma samples in the initial domain, e.g., the Y′CbCr domain) is added to the reconstructed UV samples (2232) and cropped (2236), thereby generating filtered reconstructed Y samples 2240.

In some examples, a video coder (e.g., video encoder 200 or video decoder 300) applies the transform either as across inputs, e.g., in a form of a color space conversion, or transform can be applied in spatial domain, with each component being transformed independently. In some examples, the video coder applies the transform across different input. In some examples, independently applied transform can be combined.

In one example, the video coder applies a wavelet transform to a signal (e.g., reconstructed video data) in the YUV domain spatially for each component to decompose the signal into different frequency bands from the YUV inputs, and the video coder conducts the filtering in the decomposed signal domain. In other words, the video coder conducts the filtering on the signal in a domain in which the reconstructed video data is decomposed into values corresponding to different frequency bands. At the end of the process, the inverse wavelet transform converts the signal back to the YUV domain. In another example, the wavelet transform can be the Haar wavelet.

In some examples, the transform kernel size can be from 2×2 to K×K, where K is divisible by both the height H and width W of the filtering block. The transform kernel is operator that applies a transform to input data. The size of the transform kernel is the size of the input data to which the transform is applied. In another example, the four frequency bands from the Wavelet decomposition can be arranged into four channels, where each frequency band is a block of half of the resolution of the original block. This transform is essentially downsampling the original block in the spatial domain by a factor of 2 in each dimension and quadrupling the number of channels. In another example, the same transform can be applied to other input signals, e.g., boundary strength (BS) and IPB, and the input signal with constant values can be down-sampled directly, e.g., by using Pixel unshuffle or Reshape operators.

In another example, the video coder may apply a Discrete Cosine Transform (DCT) or its integer approximation to the input signals. The kernel size can be of from 2×2 to K×K, where K is divisible by W and H of. In another example, coefficients from different frequency bands after the DCT transform can be arranged into different channels, where coefficients in the same frequency band are arranged into a block of a resolution of (W/K, H/K). This transform is essentially downsampling the original block in the spatial domain by K in each dimension and expand the number of channels by a factor of K×K. In another example, the same transform can be applied to other input signals, e.g., BS and IPB and the input signal with constant value can be downsampled directly.

In another example, the transform kernel can be trained and applied to the input signals. The kernel size can be from 1×1 to K×K, where K is divisible by both W and H. The trainable transform kernel may be implemented as convolutional neural network layers with a kernel of K×K and a stride of K_s, where K_s is divisible by W and H. In another example, different frequency bands from the trained transform, i.e., output from each kernel, can be arranged into the channel domain, where each frequency band is a block of (W/K_s, H/K_s) in resolution. The convolutional layers are essentially downsampling the original block in the spatial domain by K_s in each dimension and expand the number of channels by a factor of K_s×K_s or a number from 1 to N, where N is constrained by the model complexity. In another example, the same convolutional layers can be applied to other input signals, e.g., BS and IPB and the input signal with constant value can be down-sampled directly. In another example, the channel expansion factor can be different for each input signal.

In another example, the methods mentioned for filtering in a transform domain can also applied to separate Luma and Chroma branch of the NN models with luma/chroma split.

In another example, the number of output channels before the Pixel Shuffle may be adjusted, and the Pixel Shuffle operation may be turned on or off so that the desired spatial resolution can be obtained for the filtering. That is, after the inverse transform, if the spatial size of the output can match that of the input, then the Pixel shuffle is not needed.

In another example, the transform or trainable transform can be applied in the downsampled domain, e.g., after using Pixel-unshuffle, where pixels in the spatial domain are arranged into channel domain. In other words, the video filtering may apply the transform while the data is in a downsampled form and then subsequently upsample the data, e.g., using pixel shuffle. Thus, the video coder may downsample and/or rearrange the reconstructed video data so that the input data (e.g., reconstructed video data, predicted video data, etc.) is in a downsampled or rearranged domain. The video filtering may apply a transform to the input data in the downsampled or rearranged domain so that the input data is in the transform domain for filtering. Correspondingly, pixel shuffle can be used to re-arrange the pixel back from the channel to the spatial domain at the end of the filtering.

In another example, in order to obtain the same spatial resolution after application of the transform to luma and chroma components, the transform kernel size may be different for luma and chroma. In another example, the downsampling process may be omitted for chroma components. In another example, direct downsampling may be applied to BS and IPB data without transform applied.

In yet another example, an input signal in the Y′CbCr domain can be first converted to the linear YCbCr by applying inverse non-linearity (EOTF), specified by respective color space (ITU-R BT.2100 or BT.2020) followed by the color transform YCbCr to RGB in the linear domain and applying forward non-linearity opto-electric transfer function (OETF) on RGB data. Thus, the input domain is a Y′CbCr domain and the transform domain is an RGB domain. NN ILF filter can be applied in the resulting representation followed by the inverse operations to bring data back to Y′CbCr domain.

It is assessed that the proposed techniques may be applicable to all the NN models of different functionality and of different types of architecture and modules, which employ linear or non-linear functions on the YUV inputs.

Adoption of the techniques of this disclosure to NNVC architectures could reduce computation complexity and memory bandwidth requirements and provide a better performance. Examples described in this document are related to NN-assisted loop filtering, however, are applicable to any NN-based video coding tool that consumes input data with certain statistical properties, such as static content or sparse representation.

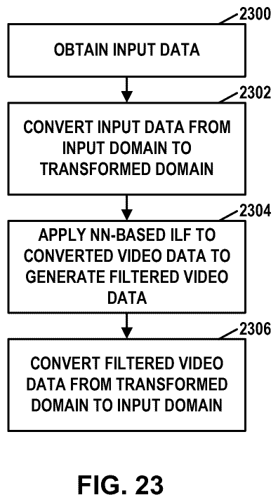

FIG. 23 is a flowchart illustrating an example operation of a video coder, in accordance with one or more techniques of this disclosure. The operation of FIG. 23 may be performed by video encoder 200 or video decoder 300. Thus, the term “coding” with respect to the operation of FIG. 23 may be applied to encoding or decoding.

In the example of FIG. 23, the video coder may obtain input data (2300). The input data includes one or more of predicted video data, reconstructed video data, quantization parameter data, boundary strength data, or IPB data. For example, in instances where the video coder is video encoder 200, reconstruction unit 214 may generate the reconstructed video data based on predicted video data and reconstructed video data. In this example, the predicted video data may be generated by motion compensation unit 224, intra-prediction unit 226, or predicted in another way. In this example, the reconstructed video data may be generated by inverse transform processing unit 212. In an example where the video coder is video decoder 300, reconstruction unit 310 may generate reconstructed video data based on predicted video data and reconstructed video data. In this example, the predicted video data may be generated by prediction processing unit 304. In this example, the reconstructed video data may be generated by inverse transform processing unit 308.

Furthermore, the video coder may convert the input data from an input domain to a transform domain to generate converted video data (2302). In some examples, filter unit 216 of video encoder 200 converts the input data. In other examples, filter unit 312 of video decoder 300 converts the input data. The input domain and the transform domain may correspond to different ways of representing input data. As an example of converting the reconstructed video data from an input domain to a transform domain, the video coder may convert predicted video data and/or reconstructed video data from a YUV domain to a non-YUV color space, such as frequency domain. In other words, the input domain may be a YUV domain and the transform domain may be a non-YUV domain. In some examples, the input domain is a Y′CbCr domain and the transform domain is a linear YCbCr domain.

In some examples, the video coder converts predicted video data and/or reconstructed video data in a form of a color space conversion. In other words, the video coder may change the color space of the predicted video data and/or reconstructed video data from one color space to another color space. In some examples, the video coder converts the predicted video data and/or the reconstructed video data in a spatial domain with each component being transformed separately. In other words, data in the input domain and the transform domain still correspond to locations in a space. In some examples, the video coder converts the video input data across multiple temporal entities of the video input data.

In some examples, the input domain is a YUV domain and the video coder applies a wavelet transform to the YUV domain for each component to decompose the video input data into a plurality of frequency bands. In this example, the transform domain is a decomposed signal domain. In some examples, the video coder applies a discrete cosine transform to the video input data.

The video coder may apply a NN-based ILF to the converted video data to generate filtered video data (2304). In some examples, filter unit 216 of video encoder 200 applies the NN-based ILF. In other examples, filter unit 312 of video decoder 300 applies the NN-based ILF. In some examples, a transform kernel size of the NN-based ILF ranges from 2×2 to K×K where K is divisible by both a height H and a width W of a filtering block. In some examples, the video coder applies different transform kernel sizes for luma and chroma.

The video coder may convert the filtered video data from the transform domain to the input domain (2306). In some examples, filter unit 216 of video encoder 200 converts the filtered video data. In other examples, filter unit 312 of video decoder 300 converts the filtered video data. In some examples, the video coder applies the NN-based ILF to separate luma and chroma branches of NN models, e.g., using an architecture similar to the unified filter 2100 of FIG. 21 but with transforms and inverse transform included. In another example, the video coder may apply the NN-based ILF to shared luma and chroma branches of NN models.

The following is a non-limiting list of clauses in accordance with one or more techniques of this disclosure.

Clause 1A. A method of coding video data, the method comprising: generating, based on predicted video data and residual data, reconstructed video data; converting the reconstructed video data from an input domain to a transform domain to generate converted video data; applying a neural network (NN)-based in-loop filter (ILF) to the converted video data to generate filtered video data; and converting the filtered video data from the transform domain to the input domain.

Clause 2A. The method of clause 1A, wherein the input representation is a YUV domain.

Clause 3A. The method of any of clauses 1A-2A, wherein the transform domain is a non-YUV color space.

Clause 4A. The method of any of clauses 1A-3A, wherein converting the video input data comprises one of: converting the video input data in a form of a color space conversion, converting the video input data in a spatial domain with each component being transformed separately, or converting the video input data across multiple temporal entities of the video input data.

Clause 5A. The method of any of clauses 1A-4A, wherein: the input representation is a YUV domain, the method further comprises applying a wavelet transform to the YUV domain for each component to decompose the video input data into a plurality of frequency bands, and the transform domain is a decomposed signal domain.

Clause 6A. The method of any of clauses 1A-5A, wherein a transform kernel size of the neural network-based in-loop filter ranges from 2×2 to K×K where K is divisible by both a height H and a width W of a filtering block.

Clause 7A. The method of any of clauses 1A-6A, wherein the method further comprises applying a discrete cosine transform to the video input data.

Clause 8A. The method of any of clauses 1A-7A, wherein applying the NN-based ILF comprises applying the NN-based ILF to separate luma and chroma branches of NN models.

Clause 9A. The method of any of clauses 1A-8A, further comprising adjusting a number of output channels before a pixel shuffle.

Clause 10A. The method of any of clauses 1A-9A, wherein the transform is applied in a down-sampled domain.

Clause 11A. The method of any of clauses 1A-10A, wherein applying the NN-based ILF comprises applying different transform kernel sizes for luma and chroma.

Clause 12A. The method of any of clauses 1A, 3A, 4A, 6A-11A, wherein the input domain is a Y′CbCr domain and the transform domain is a linear YCbCr domain.

Clause 13A. The method of any of clauses 1A-12A, wherein coding comprises decoding.

Clause 14A. The method of any of clauses 1A-13A, wherein coding comprises encoding.

Clause 15A. A device for coding video data, the device comprising one or more means for performing the method of any of clauses 1A-14A.

Clause 16A. The device of clause 15A, wherein the one or more means comprise one or more processors implemented in circuitry.

Clause 17A. The device of any of clauses 15A and 16A, further comprising a memory to store the video data.

Clause 18A. The device of any of clauses 15A-17A, further comprising a display configured to display decoded video data.

Clause 19A. The device of any of clauses 15A-18A, wherein the device comprises one or more of a camera, a computer, a mobile device, a broadcast receiver device, or a set-top box.

Clause 20A. The device of any of clauses 15A-19A, wherein the device comprises a video decoder.

Clause 21A. The device of any of clauses 15A-20A, wherein the device comprises a video encoder.

Clause 22A. A computer-readable storage medium having stored thereon instructions that, when executed, cause one or more processors to perform the method of any of clauses 1A-14A.

Clause 1B. A method of coding video data, the method comprising: obtaining input data, wherein the input data includes one or more of predicted video data, reconstructed video data, quantization parameter data, boundary strength data, or prediction mode data; converting the input data from an input domain to a transform domain to generate converted video data; applying a neural network (NN)-based in-loop filter (ILF) to the converted video data to generate filtered video data; and converting the filtered video data from the transform domain to the input domain.

Clause 2B. The method of clause 1B, wherein the input domain is a YUV domain.

Clause 3B. The method of any of clauses 1B-2B, wherein the transform domain is a non-YUV domain.

Clause 4B. The method of any of clauses 1B-3B, wherein converting the input data comprises one of: converting the reconstructed video data in a form of a color space conversion, converting the reconstructed video data in a spatial domain with each component being transformed separately, or converting the reconstructed video data across multiple temporal entities of the reconstructed video data.

Clause 5B. The method of any of clauses 1B-4B, wherein: the input domain is a YUV domain, the method further comprises applying a wavelet transform to the YUV domain for each component to decompose the reconstructed video data into a plurality of frequency bands, and the transform domain is a decomposed signal domain.

Clause 6B. The method of any of clauses 1B-5B, wherein a transform kernel size of the neural network-based in-loop filter ranges from 2×2 to K×K where K is divisible by both a height H and a width W of a filtering block.

Clause 7B. The method of any of clauses 1B-6B, wherein the method further comprises applying a discrete cosine transform to the reconstructed video data.

Clause 8B. The method of any of clauses 1B-7B, wherein applying the NN-based ILF comprises applying the NN-based ILF to separate luma and chroma branches of NN models.

Clause 9B. The method of any of clauses 1B-8B, further comprising adjusting a number of output channels before a pixel shuffle.

Clause 10B. The method of any of clauses 1B-9B, wherein converting the input data comprises: at least one of downsampling or rearranging the reconstructed video data so that the reconstructed video data is in a downsampled or rearranged domain; an applying a transform to the reconstructed video data in the downsampled or rearranged domain so that the reconstructed video data is in the transform domain for filtering.

Clause 11B. The method of any of clauses 1B-10B, wherein applying the NN-based ILF comprises applying different transform kernel sizes for luma and chroma.

Clause 12B. The method of any of clauses 1B-11B, wherein the input domain is a Y′CbCr domain and the transform domain is an RGB domain.

Clause 13B. The method of any of clauses 1B-12B, wherein coding comprises decoding.

Clause 14B. The method of any of clauses 1B-12B, wherein coding comprises encoding.

Clause 15B. A device for coding video data, the device comprising: one or more memories to store the video data; and one or more processors implemented in circuitry, the one or more processors configured to: obtain input data, wherein the input data includes one or more of predicted video data, reconstructed video data, quantization parameter data, boundary strength data, or prediction mode data; convert the input data from an input domain to a transform domain to generate converted video data; apply a neural network (NN)-based in-loop filter (ILF) to the converted video data to generate filtered video data; and convert the filtered video data from the transform domain to the input domain.

Clause 16B. The device of clause 15B, wherein the input domain is a YUV domain.

Clause 17B. The device of any of clauses 15B-16B, wherein the transform domain is a non-YUV domain.

Clause 18B. The device of any of clauses 15B-17B, wherein the one or more processors are configured to, as part of converting the input data: convert the reconstructed video data in a form of a color space conversion, convert the reconstructed video data in a spatial domain with each component being transformed separately, or convert the reconstructed video data across multiple temporal entities of the reconstructed video data.

Clause 19B. The device of any of clauses 15B-18B, wherein: the input domain is a YUV domain, the one or more processors are further configured to apply a wavelet transform to the YUV domain for each component to decompose the reconstructed video data into a plurality of frequency bands, and the transform domain is a decomposed signal domain.

Clause 20B. One or more non-transitory computer-readable storage media having stored thereon instructions that, when executed by one or more processors, cause the one or more processors to: obtain input data, wherein the input data includes one or more of predicted video data, reconstructed video data, quantization parameter data, boundary strength data, or prediction mode data; convert the input data from an input domain to a transform domain to generate converted video data; apply a neural network (NN)-based in-loop filter (ILF) to the converted video data to generate filtered video data; and convert the filtered video data from the transform domain to the input domain.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
obtaining input data, wherein the input data includes one or more of predicted video data, reconstructed video data, quantization parameter data, boundary strength data, or prediction mode data;
converting the input data from an input domain to a transform domain to generate converted video data;
applying a neural network (NN)-based in-loop filter (ILF) to the converted video data to generate filtered video data; and
converting the filtered video data from the transform domain to the input domain.

2. The method of claim 1, wherein the input domain is a YUV domain.

3. The method of claim 1, wherein the transform domain is a non-YUV domain.

4. The method of claim 1, wherein converting the input data comprises one of:
converting the reconstructed video data in a form of a color space conversion,
converting the reconstructed video data in a spatial domain with each component being transformed separately, or
converting the reconstructed video data across multiple temporal entities of the reconstructed video data.

5. The method of claim 1, wherein:
the input domain is a YUV domain,
the method further comprises applying a wavelet transform to the YUV domain for each component to decompose the reconstructed video data into a plurality of frequency bands, and
the transform domain is a decomposed signal domain.

6. The method of claim 1, wherein a transform kernel size of the neural network-based in-loop filter ranges from 2×2 to K×K where K is divisible by both a height H and a width W of a filtering block.

7. The method of claim 1, wherein the method further comprises applying a discrete cosine transform to the reconstructed video data.

8. The method of claim 1, wherein applying the NN-based ILF comprises applying the NN-based ILF to separate luma and chroma branches of NN models.

9. The method of claim 1, further comprising adjusting a number of output channels before a pixel shuffle.

10. The method of claim 1, wherein converting the input data comprises:
at least one of downsampling or rearranging the reconstructed video data so that the reconstructed video data is in a downsampled or rearranged domain; and
applying a transform to the reconstructed video data in the downsampled or rearranged domain so that the reconstructed video data is in the transform domain for filtering.

11. The method of claim 1, wherein applying the NN-based ILF comprises applying different transform kernel sizes for luma and chroma.

12. The method of claim 1, wherein the input domain is a Y′CbCr domain and the transform domain is an RGB domain.

13. The method of claim 1, wherein coding comprises decoding.

14. The method of claim 1, wherein coding comprises encoding.

15. A device for coding video data, the device comprising:
one or more memories to store the video data; and
one or more processors implemented in circuitry, the one or more processors configured to:
obtain input data, wherein the input data includes one or more of predicted video data, reconstructed video data, quantization parameter data, boundary strength data, or prediction mode data;
convert the input data from an input domain to a transform domain to generate converted video data;
apply a neural network (NN)-based in-loop filter (ILF) to the converted video data to generate filtered video data; and
convert the filtered video data from the transform domain to the input domain.

16. The device of claim 15, wherein the input domain is a YUV domain.

17. The device of claim 15, wherein the transform domain is a non-YUV domain.

18. The device of claim 15, wherein the one or more processors are configured to, as part of converting the input data:
convert the reconstructed video data in a form of a color space conversion,
convert the reconstructed video data in a spatial domain with each component being transformed separately, or
convert the reconstructed video data across multiple temporal entities of the reconstructed video data.

19. The device of claim 15, wherein:
the input domain is a YUV domain,
the one or more processors are further configured to apply a wavelet transform to the YUV domain for each component to decompose the reconstructed video data into a plurality of frequency bands, and
the transform domain is a decomposed signal domain.

20. One or more non-transitory computer-readable storage media having stored thereon instructions that, when executed by one or more processors, cause the one or more processors to:
obtain input data, wherein the input data includes one or more of predicted video data, reconstructed video data, quantization parameter data, boundary strength data, or prediction mode data;
convert the input data from an input domain to a transform domain to generate converted video data;
apply a neural network (NN)-based in-loop filter (ILF) to the converted video data to generate filtered video data; and
convert the filtered video data from the transform domain to the input domain.
